(19) United States
(12) Patent Application Publication
(10) Pub. No.: US 2013/0121666 A1
(43) Pub. Date: May 16, 2013

(54) PLAYBACK DEVICE AND AUDIO SELECTION METHOD

(71) Applicant: PANASONIC CORPORATION, Osaka (JP)

(72) Inventors: Osamu FURUYA, Osaka (JP); Satoru UEDA, Kyoto (JP); Yoshihiro NAKAHARA, Kyoto (JP); Keisuke KONDOU, Osaka (JP)

(73) Assignee: PANASONIC CORPORATION, Osaka (JP)

(21) Appl. No.: 13/723,019

(22) Filed: Dec. 20, 2012

Related U.S. Application Data
(63) Continuation of application No. PCT/JP2011/003491, filed on Jun. 17, 2011.

(30) Foreign Application Priority Data
Jun. 30, 2010 (JP) 2010-150468

(51) Int. Cl. H04N 5/76

(52) U.S. Cl. CPC H04N 5/76
USPC 386/248

(57) ABSTRACT

A playback device which performs processing using video signals and audio signals respectively corresponding to the video signals. The playback device includes: a reproduction unit which reproduces the video signals and the audio signals; a video output unit which performs processing for outputting a multi video that represents videos respectively obtained from the video signals through the reproduction performed by the reproduction unit; a playback state determination unit which determines at least one of: a playback state of at least one of the video signals; and a playback state of at least one of the audio signals; a selection unit which selects one of the audio signals based on the playback state determined by the playback state determination unit; and an audio signal output unit which outputs the audio signal selected by the selection unit.

### CROSS REFERENCE TO RELATED APPLICATIONS

This is a continuation application of PCT Patent Application No. PCT/JP2011/003491 filed on Jun. 17, 2011, designating the United States of America, which is based on and claims priority of Japanese Patent Application No. 2010-150468 filed on Jun. 30, 2010. The entire disclosures of the above-identified applications, including the specifications, drawings and claims are incorporated herein by reference in their entirety.

### FIELD

The present invention relates to a playback device which processes a multi video that represents videos, and to an audio selection method for processing such multi video.

### BACKGROUND

In recent years, the demand for flat-screen TVs has been increasing rapidly on a global basis in an environment marked by the broadcasting system that enables digitalization and offers a high picture quality and a multiple number of channels. Moreover, larger capacity and lower price of a recording medium have enabled the user to purchase a video player equipped with a hard disk drive (HDD) having a capacity in excess of several hundred GBs. This has brought a significant increase in the number of contents available for the user more than ever before.

A flat-screen TV more readily allows an increase in screen size compared to a CRT-based TV, and a simultaneous display technology, as represented by Picture in Picture (PinP), for simultaneously displaying plural images has been known as one of the functions to effectively use such a large screen. By using a multi-video display utilizing this simultaneous display technology, the user can effectively view plural contents.

In the use of the multi-video display, it has been a problem that the number of videos to be operated increases and the operations become complicated. In order to overcome such inconvenience, a system has been suggested to make the operations easy.

For example, according to the multi-video display disclosed in PTL 1, three patterns of operations are set beforehand for each event. The three patterns are an operation to automatically switch between the images, an operation not to switch between the images, and an operation to inquire the user of whether or not to switch between the images. Thus, it is possible to previously set the state in which an image is displayed, according to the user's preferences, even when an event such as an advertisement break occurs.

The multi-video display television receiver as disclosed in PTL 2 has improved its operability without significantly blocking images, by synthesizing, with an image signal, the information of each video, a video to be operated, and a mode of operation, and then displaying on-screen these information.

Whereas on the side of a playback device to play a video content, it has been a problem that an audio signal is interrupted during the operation other than play, such as stop, reverse and fast forward.

In order to overcome this inconvenience, the technology disclosed in PTL 3 has enabled a playback device to read out video signals and audio signals from plural recording media without interrupting these video and audio signals even during the period in which an audio is silent in the conventional cases.

### CITATION LIST

### Patent Literature

[PTL 1] Japanese Unexamined Patent Application Publication No. 2006-081106
[PTL 2] Japanese Unexamined Patent Application Publication No. H7-162779
[PTL 3] Japanese Unexamined Patent Application Publication No. H4-170880

### SUMMARY

### Technical Problem

However, the playback device which processes a multi video representing videos has a problem as described below.

Here, a multi video represents a first video and a second video. The first and second videos are obtained through the reproduction processing performed by a decoder or the like. A first audio corresponds to the first video and a second audio corresponds to the second video. The multi video is displayed on a display and the first audio is outputted from a speaker.

Here, in the case where an image of the second video attracts the user's attention, the user needs to operate for changing the first video from a playback state to a pause state in order to output the second audio from the speaker, and to operate for switching the audio to be outputted from the first audio to the second audio, etc. Such user's operations require a long time, e.g., more than a second. This causes a problem that the audio selection is not performed with rapidity.

### Solution to Problem

The present invention solves the conventional problem as described above, and has an object to provide a playback device which enables a rapid selection of an audio that corresponds to a multi video.

### Advantageous Effects

In order to solve the aforementioned problem, a playback device according to an aspect of the present invention performs processing using video signals and audio signals respectively corresponding to the video signals. The playback device includes: a reproduction unit which reproduces the video signals and the audio signals; a video output unit which performs processing for outputting a multi video that represents videos respectively obtained from the video signals through the reproduction performed by the reproduction unit; a playback state determination unit which determines at least one of: a playback state of at least one of the video signals; and a playback state of at least one of the audio signals; a selection unit which selects one of the audio signals based on the playback state determined by the playback state determination unit; and an audio signal output unit which outputs the audio signal selected by the selection unit.

Namely, the video output unit performs processing for outputting a multi video that represents videos respectively obtained from the video signals. The playback state determination unit determines at least one of: a playback state of at least one of the video signals; and a playback state of at least one of the audio signals. The selection unit selects one of the audio signals based on the playback state determined by the playback state determination unit.

Note that the videos representing the multi video are obtained from the video signals. That is to say that the video signals correspond to the multi video. Moreover, the audio signals from which the selection unit selects one audio signal correspond to the video signals that correspond to the multi video.

Thus, by the fact that the audio signal selection unit selects one of the audio signals based on the playback state determined by the playback state determination unit, the user's operation is not required in the selection of the audio signal. It is therefore possible to rapidly select an audio that corresponds to the multi video.

The playback state determination unit may determine a video playback state that is a playback state of at least one of the video signals, and the selection unit may select one of the audio signals based on the video playback state determined by the playback state determination unit.

The playback state determination unit may determine a video playback state that is a playback state of at least one of the video signals, and an audio playback state that is a playback state of at least one of the audio signals, and the selection unit may select one of the audio signals based on the video playback state and the audio playback state.

With this configuration, the video playback state and the audio playback state are used in the selection. Thus, it is possible to select a more appropriate audio signal.

In the case where the video playback state determined by the playback state determination unit is a special video playback state and the audio playback state determined by the playback state determination unit is a special audio playback state, the selection unit may select, from among the audio signals, an audio signal of which the playback state has not been changed and which corresponds to a video signal having an unchanged playback state.

The special video playback state may be a state in which an image represented by the video signal to be determined by the playback state determination unit remains substantially the same for a predetermined period of time or longer.

The special video playback state may be a state in which a video represented by the video signal to be determined by the playback state determination unit changes at a constant frequency.

The special audio playback state may be a state in which the audio signal to be determined by the playback state determination unit indicates that an audio is silent for a predetermined period of time or longer.

The playback state determination unit may determine, based on an external instruction, at least one of: a video playback state that is a playback state of at least one of the video signals; and an audio playback state that is a playback state of at least one of the audio signals, and the external instruction may be an instruction transmitted from a remote controller, for changing the playback state of one of the video signals.

The playback device may further include a player which plays at least one of a video signal and an audio signal, and the player may output, to an external destination, playback state information which indicates a playback state of a signal presently being played, and the playback state determination unit may further determine a playback state of the player based on the playback state information.

The playback state determination unit may determine playback states and prioritize the playback states.

The selection unit may select one of the audio signals based on the playback state determined by the playback state determination unit and a priority for selecting one of the audio signals.

A video which corresponds to the audio signal selected by the selection unit from among the videos that compose the multi video may be displayed in a manner different from a manner in which the other videos are displayed.

Thus, the user can recognize the selected audio signal.

The video which corresponds to the audio signal selected by the selection unit from among the videos that compose the multi video may be a video of which a periphery blinks on and off.

Thus, the user can easily recognize the selected audio signal.

At least one of the video signals and at least one of the audio signals may be signals obtained from a recording medium.

At least one of the video signals and at least one of the audio signals may be signals obtained from a tuner.

The playback device may further include an external audio signal input unit, and at least one of the audio signals may be an audio signal transmitted from a device that is connected to the external audio signal input unit.

An audio selection method according to an aspect of the present invention is for use in a playback device which performs processing using video signals and audio signals respectively corresponding to the video signals. The playback device includes: a reproduction unit which reproduces the video signals and the audio signals; and a video output unit which performs processing for outputting a multi video that represents videos respectively obtained from the video signals through the reproduction performed by the reproduction unit. The audio selection method includes: determining at least one of: a playback state of at least one of the video signals; and a playback state of at least one of the audio signals; selecting one of the audio signals based on the determined playback state; and outputting the selected audio signal.

The audio selection program according to another aspect of the present invention is executed by a playback device which performs processing using video signals and audio signals respectively corresponding to the video signals. The playback device includes: a reproduction unit which reproduces the video signals and the audio signals; and a video output unit which performs processing for outputting a multi video that represents videos respectively obtained from the video signals through the reproduction performed by the reproduction unit. The audio selection program includes: determining at least one of: a playback state of at least one of the video signals; and a playback state of at least one of the audio signals; selecting one of the audio signals based on the determined playback state; and outputting the selected audio signal.

Note that a part or all of the components composing the playback device as described above may be comprised in a single system LSI (Large Scale Integration).

The present invention may be realized as an audio selection method in which the operations of the characteristic components included in the playback device are performed. Moreover, the present invention can also be achieved as a program that causes a computer to execute each of the operations in the aforementioned audio selection method. Furthermore, the present invention may be realized even as a computer readable recording medium that stores such program. The program may be distributed via a transmitting medium such as the Internet.

According to the present invention, it is possible to rapidly select an audio that corresponds to a multi video.

### BRIEF DESCRIPTION OF DRAWINGS

These and other objects, advantages and features of the invention will become apparent from the following description thereof taken in conjunction with the accompanying drawings that illustrate a specific embodiment of the present invention. In the Drawings:

FIG. 1 is a block diagram showing a configuration of a playback device according to Embodiment 1.

FIG. 2 is a flowchart showing a playback state handling processing.

FIG. 3 is a block diagram showing a configuration of the playback device according to Embodiment 2.

FIG. 4 is a block diagram showing a configuration of a playback state management unit.

FIG. 5 is a diagram for describing playback states to be determined.

FIG. 6 is a diagram showing an example of settings for automatically switching between audios.

FIG. 7 is a diagram showing an example of settings in which priorities are taken into consideration, in the case where alternative audio signals are provided.

FIG. 8 is a diagram showing an example of a multi video.

FIG. 9 is a diagram showing another example of a multi video.

FIG. 10 is a flowchart illustrating a playback state handling processing A.

FIG. 11 is a block diagram showing an example of a configuration of the playback device.

FIG. 12 is a block diagram showing a characteristic functional configuration of the playback device.

### DESCRIPTION OF EMBODIMENTS

Hereinafter, embodiments of the present invention shall be described with reference to the accompanying Drawings. It should be noted that the components with the same signs operate in the same manner through the embodiments; therefore, the description thereof shall be abbreviated in some cases. The following embodiments are embodied examples of the present invention and they shall not limit the technical scope of the present invention.

### Embodiment 1

Embodiment 1 describes a playback device which includes two recording media, two video decoders and two audio decoders, and is capable of outputting a signal of a multi video (multi-screen). Here, the multi video is a video representing plural kinds of videos.

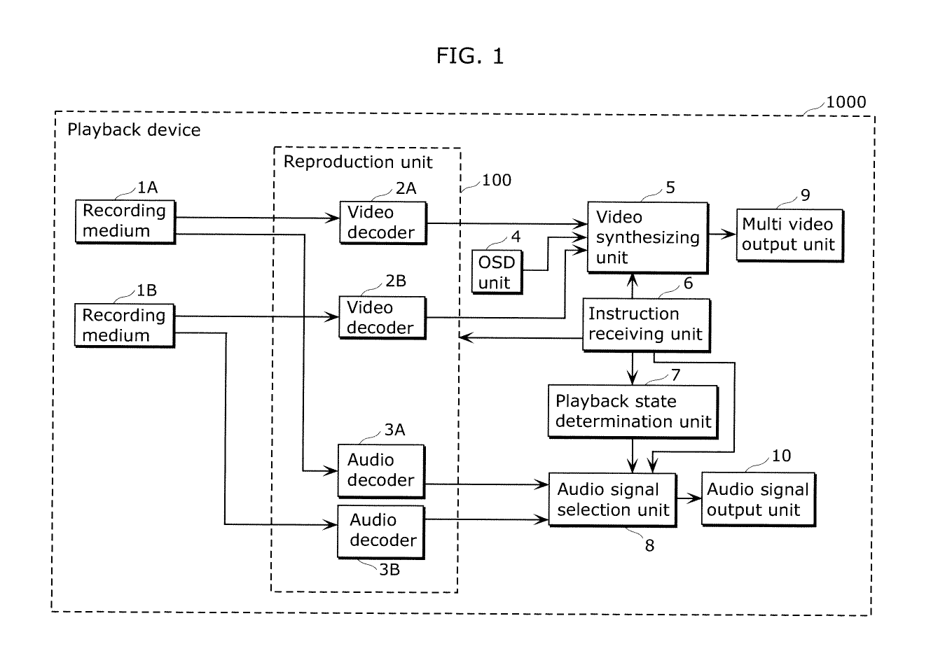

FIG. 1 is a block diagram showing a configuration of a playback device 1000 according to Embodiment 1. A monitor and a speaker which are not shown in the diagram are connected to the playback device 1000. The monitor is a display capable of displaying videos. The playback device 1000 transmits a generated video signal to the monitor that is externally set and also transmits an audio signal to the speaker. The details will be described later.

As shown in FIG. 1, the playback device 1000 includes recording media 1A and 1B, a reproduction unit 100, an On-Screen-Display (OSD) unit 4, a video synthesizing unit 5, an instruction receiving unit 6, a playback state determination unit 7, an audio signal selection unit 8, a multi video output unit 9, and an audio signal output unit 10.

The recording media 1A and 1B are, for instance, Hard Disk Drives (HDDs) or flash memories.

The recording media 1A and 1B may not be included in the playback device 1000. They may be media that can be easily detached from the playback device 1000. In this case, the recording media 1A and 1B are optical media, SD cards, USB memories, or the like. The examples of the optical media are Blu-ray Discs (BDs) and Digital Versatile Discs (DVDs).

In each of the recording media 1A and 1B, a video signal coded by a video codec and an audio signal coded by an audio codec are recorded.

In recent years, it is common that a video signal and an audio signal are compression coded by a video codec and an audio codec respectively, and then recorded into a recording medium. In many cases, synchronization information and management information of the video signal and the audio signal are multiplexed by a system codec.

The video codec is, e.g., Moving Picture Experts Group (MPEG)-2 or MPEG-4 AVC, and the audio codec is, e.g., Advanced Audio Coding (AAC) or Dolby-AC3. The system codec is, e.g., QuickTime, MPEG-2 PS, or MPEG-2 TS.

The reproduction unit 100 performs reproduction of video signals and audio signals, and includes video decoders 2A and 2B, and audio decoders 3A and 3B.

The video decoder 2A reads out a video signal recorded in the recording medium 1A, decodes (reproduces) the video signal, and transmits the decoded video signal to the video synthesizing unit 5. Hereinafter, the video signal transmitted by the video decoder 2A may be also referred to as “first video signal”, and the video represented by the first video signal is also referred to as “first video”.

The video decoder 2B reads out a video signal recorded in the recording medium 1B, decodes (reproduces) the video signal, and transmits the decoded video signal to the video synthesizing unit 5. Hereinafter, the video signal transmitted by the video decoder 2B may be also referred to as “second video signal”, and the video represented by the second video signal is also referred to as “second video”.

The audio decoder 3A decodes (reproduces) an audio signal recorded in the recording medium 1A and transmits the decoded audio signal to the audio signal selection unit 8. Hereinafter, the audio signal transmitted by the audio decoder 3A is also referred to as “the first audio signal”, and the audio represented by the first audio signal is also referred to as “the first audio”.

The audio decoder 3B decodes (reproduces) an audio signal recorded in the recording medium 1B and transmits the decoded audio signal to the audio signal selection unit 8. Hereinafter, the audio signal transmitted by the audio decoder 3B is also referred to as “the second audio signal”, and the audio represented by the second audio signal is also referred to as “the second audio”.

The first video and the second video respectively correspond to the first audio and the second audio.

The OSD unit 4 performs processing for drawing characters and graphics intended for on-screen display. To be more precise, the OSD unit 4 generates an image for on-screen display and generates a video signal (hereinafter referred to as “OSD video signal”) that represents the generated image. The OSD unit 4 then transmits the OSD video signal to the video synthesizing unit 5 when necessary.

The video synthesizing unit 5 generates a multi video that represents the first video represented by the first video signal and the second video represented by the second video signal. In the multi video, the first video and the second video are arranged in such a manner that they do not overlap each other (Picture by Picture). Note, however, that the first video and the second video may be arranged in such a manner that they overlap in the multi video.

Note that in the generation of the multi video, the videos represented by the multi video are reduced in size by the video synthesizing unit 5 when necessary.

The multi video thus represents the videos respectively obtained from the video signals through the reproduction performed by the reproduction unit 100.

Moreover, the video synthesizing unit 5 overlaps, when necessary, the video represented by the OSD video signal onto the generated multi video. The method of overlapping the video represented by the OSD video signal is a known technology; therefore, the details shall not be described here.

The video synthesizing unit 5 then transmits the video signals representing the multi video (hereinafter referred to as “multi video signals”) to the multi video output unit 9.

The multi video output unit 9 transmits (outputs) the received multi video signal to the external monitor not shown in the diagram. The monitor displays the multi video represented by the received multi video signal. Thus, the multi video output unit 9 is a video output unit that performs processing for outputting a multi video.

The instruction receiving unit 6 accepts a control instruction by receiving a control signal that indicates the control instruction. The control signal is, for instance, a control signal transmitted from a remote controller that is not shown in the diagram via a wireless communication by the user who operates the remote controller.

The control instruction is one of a playback control instruction, a video composition instruction, an audio selection instruction, or the like.

The playback control instruction is an instruction related to the reproduction of a video signal, and is normally an instruction such as normal playback, fast forward, pause, and reverse.

Hereinafter, a playback state in which a video represented by the video signal is paused is also referred to as “pause state”.

The pause state is a state in which an image represented by the video signal remains the same or substantially the same for a predetermined period of time or longer.

Moreover, a playback state in which a video represented by a video signal is fast forwarded is also referred to as “fast-forward state”. A playback state in which a video represented by a video signal is reversed is also referred to as “reverse state”. A playback state in which a video represented by a video signal is played as normal is also referred to as “normal playback state”.

Hereinafter, each of the pause state, fast-forward state and reverse state is also referred to, as a whole, as “special playback state”. Moreover, each of the fast-forward state and the reverse state is also referred to, as a whole, as “trick play state”.

In the case when the received control instruction is a playback control instruction, the instruction receiving unit 6 transmits the playback control instruction to the reproduction unit 100 and the playback state determination unit 7.

In the case when the playback control instruction is an instruction to change a playback state of the video signal decoded (reproduced) by the video decoder 2A to a pause state, the video decoder 2A included in the reproduction unit 100 stops decoding the video signal, and transmits the video signal which represents the same frame (image), as the first video signal to the video synthesizing unit 5.

Thus, the first video represented by the multi video generated by the video synthesizing unit 5 shows the same frame (image). That is to say that the playback state of the first video signal is changed to a pause state.

The video composition instruction is a multi-video generation instruction, a single video instruction, or the like. In the case when the control instruction is a video composition instruction, the instruction receiving unit 6 transmits the video composition instruction to the video synthesizing unit 5.

The multi video generation instruction is an instruction to cause the video synthesizing unit 5 to generate the multi video as described above. The single video instruction is an instruction not to cause the video synthesizing unit 5 to generate the multi video.

When receiving a single video instruction, the video synthesizing unit 5 does not perform processing for generating the multi video as described above, but transmits a video signal that represents one video (e.g., the first video or the second video) to the multi video output unit 9.

The audio selection instruction is an instruction for the audio signal selection unit 8 to select a signal to be outputted. When the received control instruction is an audio selection instruction, the instruction receiving unit 6 transmits the audio selection instruction to the audio signal selection unit 8.

Here, the audio selection instruction shall be, for instance, an instruction for transmitting the first audio signal transmitted from the audio decoder 3A, to the audio signal output unit 10. In this case, the audio signal selection unit 8 transmits the first audio signal to the audio signal output unit 10 according to the received audio selection instruction.

Note here that the control signal received by the instruction receiving unit 6 may be a control signal which is transmitted from a circuit not shown in the diagram by the user operating keys (buttons) that are not shown in the diagram and are equipped in the playback device 1000.

The playback state determination unit 7 determines a playback state of each signal that is to be decoded (reproduced) by the reproduction unit 100. The playback state determination unit 7 transmits an audio selection instruction indicating whether to select the first audio signal or the second audio signal, to the audio signal selection unit 8.

In the case where a playback state of a video signal is a pause state, a reverse state, or other state, an audio of the video signal is usually silent in a single player. However, the playback state determination unit 7 determines a playback state of an audio signal, and in the case where the playback state indicates that an audio of the audio signal is silent, the playback state determination unit 7 can select another audio that is different from the audio of that audio signal.

It should be noted that the playback state determination unit 7 has a function to memorize an audio signal that has previously been selected. With this function, the playback state determination unit 7 can get the previously selected audio signal outputted again when a playback state of an audio signal is changed to a playback state indicating an output of sound.

The audio signal selection unit 8 selects either one of the first audio signal and the second audio signal according to the audio selection instruction that has been transmitted from the instruction receiving unit 6 or the audio selection instruction that has been transmitted from the playback state determination unit 7.

The audio selection instruction transmitted from the instruction receiving unit 6 is, for example, an instruction generated through the user's operation using a remote controller, as has been mentioned above.

Hereinafter, the user's operation using a remote controller is referred to as “remote control operation U”.

Then, the audio signal selection unit 8 transmits the selected audio signal to the audio signal output unit 10.

The audio signal output unit 10 transmits the received audio signal to the speaker. That is to say that the audio signal output unit 10 externally outputs the received audio signal. The speaker outputs an audio represented by the received audio signal.

Note that headphones may be connected to the playback device 1000. In this case, the audio signal output unit 10 transmits the received audio signal to the headphones.

As has been described above, the audio signal selection unit 8 can select either of the first audio signal and the second audio signal through the remote control operation U. However, the two steps (remote control operation U) for selecting an audio signal after having changed a playback state of either of the first and second video signals impose burdens on the user as this operation is required more frequently.

For example, with the use of the playback device 1000 according to the present embodiment, a multi video representing the first video and the second video is displayed on the monitor, and thus, the user can view both the first video and the second video in parallel.

Here, pretending that the user is viewing the first video, the first audio corresponding to the first video, and the second video, and the second video attracts the user's attention. In other words, the multi video representing the first and second videos is displayed on the monitor and the first audio is being outputted from the speaker.

In this case, with the view to concentrate on the viewing of the second video, the user operates the playback device 1000 to change a playback state of the first video to a pause state, and also, to switch the audio that is presently being played from the first audio to the second audio corresponding to the second video.

Then, after having viewed the second video and the second audio for a while, the user operates again the playback device 1000 so that the audio is switched from the second audio to the first audio.

In the case of causing the playback device 1000 to achieve the processing described above through the conventional remote control operation U, the user is required to perform the following four steps of remote control operations J1, J2, J3, and 34.

The remote control operation J1 is a remote control operation U for changing a playback state of the first video to a pause state (e.g., an operation of pressing a pause button).

The remote control operation J2 is a remote control operation U for switching the audio that is presently being played from the first audio to the second audio (e.g., an operation of pressing an audio switching button).

The remote control operation J3 is a remote control operation U for switching the audio that is presently being played from the second audio to the first audio (e.g., an operation of pressing an audio switching button).

The remote control operation J4 is a remote control operation U for playing the first video that is in a pause state (e.g., an operation of pressing a play button).

Nevertheless, with the use of the playback device 1000 according to the present embodiment, it is possible to perform the processing as described above through the following two steps of remote control operations N1 and N2. Hereinafter, the processing performed with regard to playback states by the playback device 1000 is referred to as “playback state handling processing”.

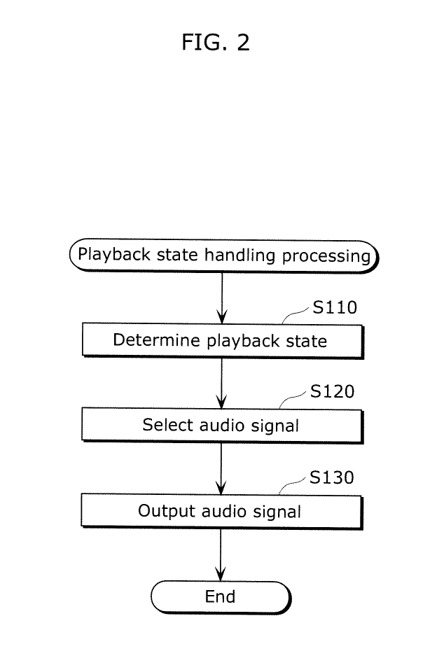

FIG. 2 is a flowchart showing such playback state handling processing.

The video synthesizing unit 5, the audio signal selection unit 8, and the audio signal output unit 10 in the playback device 1000 shall perform the following processing.

The video synthesizing unit 5 transmits (outputs), to the monitor, the multi video signal which represents the multi video representing the first video and the second video. The audio signal selection unit 8 has selected the first audio signal and transmits the first audio signal to the audio signal output unit 10. The audio signal output unit 10 transmits the first audio signal to the speaker. Having received the first audio signal, the speaker outputs the first audio. In this case, a playback state of the first video (the first video signal) is a normal playback state.

In the state as described above, the remote control operation N1 is firstly performed by the user. The remote control operation N1 is a remote control operation U for changing the playback state of the first video to a pause state. Namely, the remote control operation N1 is the same as the remote control operation J1 which has been described above.

In this case, by receiving, from the remote controller, a control signal that indicates a playback control instruction for changing the playback state of the first video (the first video signal) to a pause state, the instruction receiving unit 6 accepts the playback control instruction. In such case, the instruction receiving unit 6 transmits the playback control instruction to the reproduction unit 100 and the playback state determination unit 7.

In this case, the video decoder 2A included in the reproduction unit 100 stops the decoding of the video signal according to the playback control instruction, and transmits the video signal for displaying the same frame (image) to the video synthesizing unit 5 as the first video signal.

Thus, the first video represented by the multi video generated by the video synthesizing unit 5 shows the same frame (image). That is to say that the playback state of the first video signal is changed to a pause state.

In this case, by receiving the playback control instruction for changing the playback state of the first video (the first video signal), the playback state determination unit 7 determines that “the first audio is not to be outputted because the playback state of the first video is changed to a pause state”.

In other words, the playback state determination unit 7 determines that the playback state of the first video (the first video signal) is in a pause state that is regarded as a special video playback state (S110). That is, the playback state determination unit 7 determines that the playback state of the first video (the first video signal) has been changed from a normal playback state to a pause state.

Note that the playback state determination unit 7 also determines, in this case, that the playback state of the second video (the second video signal) is a normal playback state.

Namely, the playback state determination unit 7 determines a playback state of at least one of the video signals (hereinafter also referred to as “video playback state”).

The playback state determination unit 7 then transmits an audio selection instruction for selecting the second audio signal to the audio selection unit 8. Here, the audio selection instruction is an instruction for switching the audio presently being played from the first audio to the second audio.

Receiving the audio selection instruction, the audio signal selection unit 8 selects the second audio signal instead of the first audio signal (S120).

In the case where the video playback state determined by the playback state determination unit 7 is a special video playback state, the audio signal selection unit 8 functioning as a selection unit selects, from among the audio signals, the second audio signal other than the first audio signal corresponding to the first video signal of which the playback state has been changed.

In other words, in the case where the playback state determination unit 7 has determined that the playback state of one of the video signals is changed, the audio signal selection unit 8 selects the second audio signal other than the first audio signal corresponding to the first video signal of which the playback state has been changed.

Namely, the audio signal selection unit 8 functioning as a selection unit selects one of the audio signals based on the playback states determined by the playback state determination unit 7.

The audio signal selection unit 8 then transmits the selected second audio signal to the audio signal output unit 10.

The audio signal output unit 10 transmits (outputs) the second audio signal to the speaker that is set externally (S130). Thus, the audio outputted from the speaker is switched from the first audio to the second audio. More precisely, the audio signal output unit 10 outputs the audio signal selected by the audio signal selection unit 8 functioning as a selection unit.

Next, the remote control operation N2 is performed by the user. The remote control operation N2 is a remote control operation U for playing the first video which is in a pause state. Namely, the remote control operation N2 is the same as the remote control operation J4 which has been described above.

In this case, by receiving, from the remote controller, a control signal that indicates a playback control instruction for changing a playback state of the first video (the first video signal) to a normal playback state, the instruction receiving unit 6 accepts the playback control instruction. In such case, the instruction receiving unit 6 transmits the playback control instruction to the reproduction unit 100 and the playback state determination unit 7.

In this case, the video decoder 2A included in the reproduction unit 100 starts the decoding of the video signal which has been stopped, according to the playback control instruction, and transmits the first video signal obtained through the decoding to the video synthesizing unit 5. Namely, the video decoder 2A changes the playback state of the first video signal to a normal playback state.

Thus, the playback state of the first video represented by the multi video generated by the video synthesizing unit 5 is changed to a normal playback state.

In this case, upon receiving the playback control instruction for changing a playback state of the first video (the first video signal) to a normal playback state, the playback state determination unit 7 determines that “the first audio is to be outputted because the playback state of the first video is changed to a normal playback state”.

In other words, the playback state determination unit 7 determines that the playback state of the first video (the first video signal) is a normal playback state (S110). That is, the playback state determination unit 7 determines that the playback state of the first video (the first video signal) is changed from a pause state to a normal playback state.

The playback state determination unit 7 then transmits an audio selection instruction for selecting the first audio signal to the audio selection unit 8. Here, the audio selection instruction is an instruction for switching an audio presently being played from the second audio to the first audio.

Upon receiving the audio selection instruction, the audio signal selection unit 8 selects the first audio signal instead of the second audio signal (S120). Then, the audio signal selection unit 8 transmits the selected first audio signal to the audio signal output unit 10.

The audio signal output unit 10 transmits (outputs) the first audio signal to the externally-set speaker (S130). Thus, the audio outputted from the speaker is switched from the second audio to the first audio.

Note that in the aforementioned processing, an example in which the playback control instruction is an instruction for changing a playback state of a video (video signal) to a pause state is described. However, according to the present invention, the same processing as described above is performed even in the case where the playback control instruction is an instruction for changing a playback state of a video (video signal) to a fast-forward state or a reverse state.

Namely, even when a playback state of a video (video signal) is changed to either a fast-forward state or a reverse state, the same processing as performed in the case where a playback state of a video (video signal) is changed to a pause state shall be performed.

As has been described above, according to the present embodiment, the playback state determination unit 7 determines playback states of a video (video signal) and transmits an audio selection instruction to the audio signal selection unit 8 according to the determined playback states. The audio signal selection unit 8 selects an audio signal according to the audio selection instruction. The audio signal output unit 10 outputs the audio signal selected by the audio signal selection unit 8.

Note that the first audio signal and the second audio signal which are to be selected by the audio signal selection unit 8 respectively correspond to the first video and the second video. In other words, the first audio signal and the second audio signal to be selected by the audio signal selection unit 8 correspond to the multi video representing the first video and the second video.

Thus, by the fact that the audio signal selection unit 8 selects one of the audio signals (the first and second audio signals) based on the playback states determined by the playback state determination unit 7, the user's operation or the like is not required in the selection of the audio signal. It is therefore possible to rapidly select an audio that corresponds to the multi video.

With the conventional technique, in a state where a playback state of the first video (the first video signal) is a special playback state (e.g., pause state, fast-forward state, or other state) and the first audio is silent (hereinafter referred to as “state A”), for instance, the user's operation has been necessary in order to output the second audio.

However, in the present embodiment, it is possible in the state A to output the second audio different from the first audio without any user's operation. This enables the user to effectively view the first video and the second video in parallel.

Note that it is described in the present embodiment that two video signals and two audio signals are outputted from two recording media (recording media 1A and 1B); however, the number of recording media may be one or more than three.

It is also described in the present embodiment that two video decoders and two audio decoders are used; however, the present invention shall not be limited to this. For instance, the scale of the circuit may be reduced by using one video decoder and one audio decoder, which can be realized by performing time-division processing and using a decode buffer having a larger capacity. Also, the power use may be cut down through load sharing which can be realized by having three or more video decoders and three or more audio decoders.

It is also described in the present embodiment that the video decoders and the audio decoders are used as reproduction means to perform decoding; however, the present invention is not limited to this. For example, in the case where video signals and audio signals are not properly compression coded, a configuration for reading the video signals and the audio signals from the recording media and outputting these signals becomes an equivalent of such reproduction means. Thus, the video decoders and the audio decoders are not necessarily required.

It is described in the present embodiment that a video signal and an audio signal are read from a recording medium; however, the present invention is not limited to this. The video signal and the audio signal may have been the signals that are recorded at the same time, or the signals may not be related to each other.

Moreover, it is described in the present embodiment that a video signal and an audio signal are directly read from a recording medium and then decoded by video/audio decoders; however, the present invention is not limited to this. For example, a multiplexed stream may be read from a recording medium and then multiply-separated so that the video/audio decoders decode the multiply-separated stream.

It is also described in the present embodiment that the multi video output unit is configured to transmit (output), to a monitor, a signal of the multi video representing videos; however, the present invention is not limited to this. The multi video output unit may be configured to transmit (output) each one of video signals to plural monitors. Moreover, it may be configured to transmit (output) one or more video signals to the respective monitors.

Furthermore, it is described in the present embodiment that the number of audio signals outputted by the audio signal selection unit is one; however, the present invention is not limited to this. For instance, in order to realize an output of plural audios, plural output terminals may be set in the audio signal output unit. Moreover, the same sound or different sounds may be heard from different devices as in the combination of headphones and a speaker, or the like.

### Embodiment 2

Embodiment 2 describes a playback device that includes four tuners, four video decoders, four audio decoders, two external video signal input units, and two external audio signal input units.

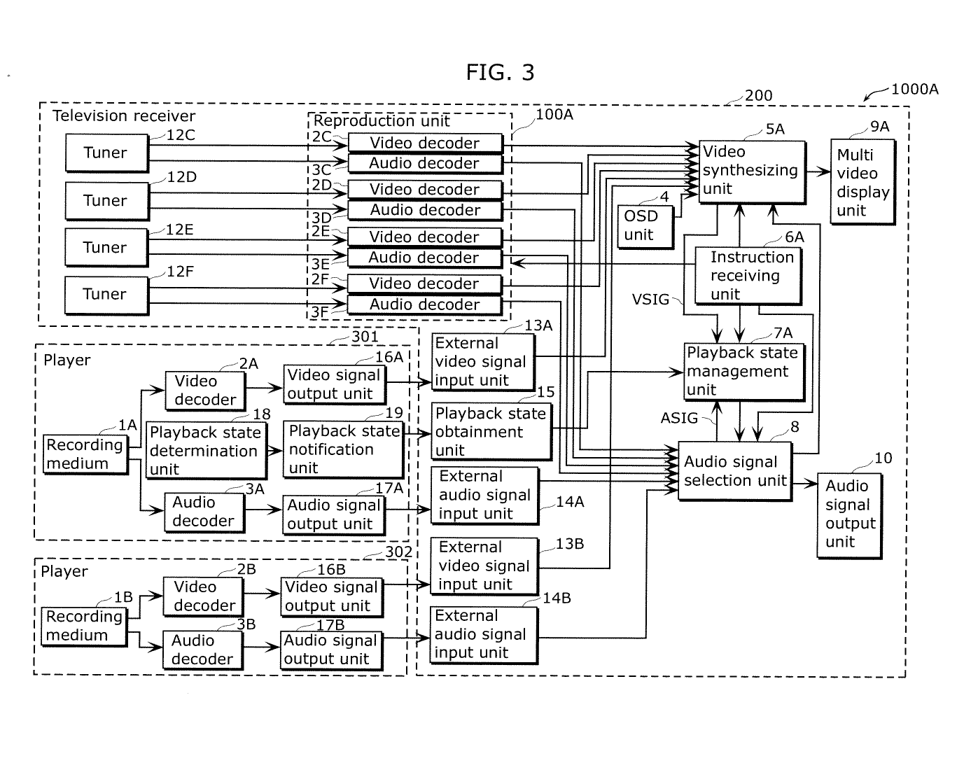

FIG. 3 is a block diagram showing a configuration of a playback device 1000A according to Embodiment 2.

The playback device 1000A includes a television receiver 200, and players 301 and 302.

The television receiver 200 is a video display capable of displaying a multi video (multi-screen). Note here that the video display included in the player 1000A is not restricted to a television receiver. It may be other device if capable of displaying videos.

The television receiver 200 is connected to the players 301 and 302, respectively.

The television receiver 200 includes tuners 12C, 12D, 12E and 12F, a reproduction unit 100A, an OSD unit 4, a video synthesizing unit 5A, an instruction receiving unit 6A, a playback state management unit 7A, the audio signal selection unit 8, a multi video display unit 9A, the audio signal output unit 10, external video signal input units 13A and 13B, external audio signal input units 14A and 14B, and a playback state obtainment unit 15.

Each of the tuners 12C, 12D, 12E and 12F receives broadcast waves from an antenna that is not shown in the diagram. Each of the tuners 12C, 12D, 12E, and 12F obtains a video signal and an audio signal by demodulating the received broadcast waves, and transmits the video signal and the audio signal to a video decoder and an audio decoder, respectively.

Hereinafter, the video signal and the audio signal obtained through the demodulation of the broadcast waves performed by each tuner are referred to as “broadcast video signal” and “broadcast audio signal”, respectively.

A broadcast video signal and a broadcast audio signal are signals equivalent to a video signal and an audio signal recorded in the recording medium 1A. More precisely, a broadcast video signal is a video signal coded by a video codec, and a broadcast audio signal is an audio signal coded by an audio codec.

The reproduction unit 100A performs reproduction of video signals and audio signals, and includes video decoders 2C, 2D 2E, and 2F, and audio decoders 3C, 3D, 3E, and 3F.

The tuner 12C transmits a broadcast video signal and a broadcast audio signal to the video decoder 2C and the audio decoder 3C, respectively. The tuner 12D transmits a broadcast video signal and a broadcast audio signal to the video decoder 2D and the audio decoder 3D, respectively.

The tuner 12E transmits a broadcast video signal and a broadcast audio signal to the video decoder 2E and the audio decoder 3E, respectively. The tuner 12F transmits a broadcast video signal and a broadcast audio signal to the video decoder 2F and the audio decoder 3F, respectively.

Each of the video decoders 2C, 2D, 2E, and 2F has the same function as that of the video decoders 2A and 2B in FIG. 1; therefore, the detailed description shall not be repeated. The following is a brief explanation of the video decoders 2C, 2D, 2E, and 2F.

The video decoder 2C decodes (reproduces) a received broadcast video signal and transmits the decoded broadcast video signal to the video synthesizing unit 5A. Hereinafter, the broadcast video signal transmitted by the video decoder 2C is also referred to as “the third video signal”, and the video represented by the third video signal is also referred to as “the third video”.

The video decoder 2D decodes (reproduces) a received broadcast video signal and transmits the decoded broadcast video signal to the video synthesizing unit 5A. Hereinafter, the broadcast video signal transmitted by the video decoder 2D is also referred to as “the fourth video signal”, and the video represented by the fourth video signal is also referred to as “the fourth video”.

The video decoder 2E decodes (reproduces) a received broadcast video signal and transmits the decoded broadcast video signal to the video synthesizing unit 5A. Hereinafter, the broadcast video signal transmitted by the video decoder 2E is also referred to as “the fifth video signal”, and the video represented by the fifth video signal is also referred to as “the fifth video”.

The video decoder 2F decodes (reproduces) a received broadcast video signal and transmits the decoded broadcast video signal to the video synthesizing unit 5A. Hereinafter, the broadcast video signal transmitted by the video decoder 2F is also referred to as “the sixth video signal”, and the video represented by the sixth video signal is also referred to as “the sixth video”.

Each of the audio decoders 3C, 3D, 3E, and 3F has the same function as that of the audio decoders 3A and 3B in FIG. 1; therefore, the detailed description shall not be repeated. The following is a brief explanation of the audio decoders 3C, 3D, 3E, and 3F.

The audio decoder 3C decodes (reproduces) a received broadcast audio signal and transmits the decoded broadcast audio signal to the audio signal selection unit 8. Hereinafter, the broadcast audio signal transmitted by the audio decoder 3C is also referred to as “the third audio signal”, and the audio represented by the third audio signal is also referred to as “the third audio”.

The audio decoder 3D decodes (reproduces) a received broadcast audio signal and transmits the decoded broadcast audio signal to the audio signal selection unit 8. Hereinafter, the broadcast audio signal transmitted by the audio decoder 3D is also referred to as “the fourth audio signal”, and the audio represented by the fourth audio signal is also referred to as “the fourth audio”.

The video decoder 3E decodes (reproduces) a received broadcast audio signal and transmits the decoded broadcast audio signal to the audio signal selection unit 8. Hereinafter, the broadcast audio signal transmitted by the audio decoder 3E is also referred to as “the fifth audio signal”, and the audio represented by the fifth audio signal is also referred to as “the fifth audio”.

The video decoder 3F decodes (reproduces) a received broadcast audio signal and transmits the decoded broadcast audio signal to the audio signal selection unit 8. Hereinafter, the broadcast audio signal transmitted by the audio decoder 3F is also referred to as “the sixth audio signal”, and the audio represented by the sixth audio signal is also referred to as “the sixth audio”.

The third, fourth, fifth and sixth videos respectively correspond to the third, fourth, fifth and sixth audios.

The playback state obtainment unit 15 is capable of obtaining a playback state (operating state) of the player that is externally set, through an external communication means. The playback state obtainment unit 15 is connected to the player 301 via a communication cable. For example, an Ethernet (registered trademark) terminal is set in the playback state obtainment unit 15. In this case, the playback state obtainment unit 15 is connected to the player 301 via a Local Area Network (LAN) cable. With such configuration, the playback state obtainment unit 15 communicates with the player 301.

The player 301 includes the recording medium 1A, the video decoder 2A, the audio decoder 3A, a video signal output unit 16A, an audio signal output unit 17A, a playback state determination unit 18, and a playback state notification unit 19.

Each of the recording medium 1A, the video decoder 2A and the audio decoder 3A which are shown in FIG. 3 has the same function as that of the recording medium 1A, the video decoder 2A and the audio decoder 3A in FIG. 1; therefore, the detailed description shall not be repeated. The following is a brief description of the recording medium 1A, the video decoder 2A and the audio decoder 3A.

The video decoder 2A decodes (reproduces) a video signal recorded in the recording medium 1A, and transmits the decoded video signal to the video signal output unit 16A. As has already been described above, the video signal transmitted by the video decoder 2A is the first video signal, and a video represented by the first video signal is the first video.

The audio decoder 3A decodes (reproduces) an audio signal recorded in the recording medium 1A, and transmits the decoded audio signal to the audio signal output unit 17A.

Namely, the player 301 reproduces at least one of a video signal and an audio signal.

As has already been described above, the audio signal transmitted by the audio decoder 3A is the first audio signal, and an audio represented by the first audio signal is the first audio.

The video signal output unit 16A transmits the received first video signal to the external video signal input unit 13A via a cable. The audio signal output unit 17A transmits the received first audio signal to the external audio signal input unit 14A via a cable.

The external video signal input unit 13A transmits the received video signal to the video synthesizing unit 5A, and the external audio signal input unit 14A transmits the received first audio signal to the audio signal selection unit 8.

With this configuration, the television receiver 200 can perform a display of the video and an output of the audio, using the video signal and the audio signal which are transmitted from the player 301.

Namely, at least one of the audio signals (the first through sixth audio signals) is the audio signal which is transmitted from the device (player 301) that is connected to the external audio signal input unit 14A.

Plural connecting methods are provided for transmitting a video signal and an audio signal as there are plural shapes of terminals. Here, the player 301 transmits the video signal and the audio signal to the television receiver 200 via a High-Definition Multimedia Interface (HDMI) cable, for instance.

More precisely, the video signal output unit 16A and the audio signal output unit 17A are respectively connected to the external video signal input unit 13A and the external audio signal input unit 14A via an HDMI cable.

The HDMI cable is capable of transmitting a video signal and an audio signal at the same time; however, in FIG. 3, different paths are shown: one for transmitting a video signal; and the other for transmitting an audio signal, for the sake of convenience. FIG. 3 thus shows a configuration in which the video signal output unit 16A and the audio signal output unit 17A are respectively connected to the external video signal input unit 13A and the external audio signal input unit 14A. As a matter of fact, the video signal output unit 16A and the audio signal output unit 17A are respectively connected to the external video signal input unit 13A and the external audio signal input unit 14A via an HDMI cable.

The playback state determination unit 18 manages (recognizes) a playback state of the player 301. The playback state determination unit 18 externally notifies a playback state (operating state) of the player 301 via the playback state notification unit 19. The playback state (operating state) of the player 301 is a playback state of a signal that is being reproduced by the player 301.

Hereinafter, the information indicating a playback state (operating state) of the player 301 is referred to as “playback state information”.

The playback state notification unit 19 is connected to the playback state obtainment unit 15 via a communication cable. As an example, an Ethernet (registered trademark) terminal is set to the playback state notification unit 19. In this case, the playback state notification unit 19 is connected to the playback state obtainment unit 15 via a LAN cable. Namely, the playback state determination unit 18 transmits the playback state information that indicates a playback state (operating state) of the player 301 to the television receiver 200 (the playback state obtainment unit 15) via the playback state notification unit 19.

In other words, the player 301 externally outputs the playback state information which indicates a playback state of a signal that is being reproduced by the player 301.

The playback state obtainment unit 15 transmits the received playback state information to the playback state management unit 7A.

With this configuration, the television receiver 200 is capable of obtaining in real time a playback state (operating state) of the player 301.

The player 302 includes the recording medium 1B, the video decoder 2B, the audio decoder 3B, a video signal output unit 16B, and an audio signal input unit 17B.

Each of the recording medium 1B, the video decoder 2B, and the audio decoder 3B which are shown in FIG. 3 has the same function as that of the recording medium 1B, the video decoder 2B, and the audio decoder 3B shown in FIG. 1; therefore, the detailed description shall not be repeated. The following is a brief explanation of the recording medium 1B, the video decoder 2B, and the audio decoder 3B.

The video decoder 2B decodes (reproduces) a video signal recorded in the recording medium 1B, and transmits the decoded video signal to the video signal output unit 16B. As has already been described above, the video signal transmitted by the video decoder 2B is the second video signal, and the video represented by the second video signal is the second video.

The audio decoder 3B decodes (reproduces) an audio signal recorded in the recording medium 1B, and transmits the decoded audio signal to the audio signal output unit 17B. As has already been described above, the audio signal transmitted by the audio decoder 3B is the second audio signal, and the audio represented by the second audio signal is the second audio.

The video signal output unit 16B is connected to the external video signal input unit 13B via a component cable, for instance. The audio signal output unit 17B is connected to the external audio signal input unit 14B via an RCA stereo cable, for instance.

The video signal output unit 16B transmits the received second video signal to the external video signal input unit 13B via the component cable. In this case, the second video signal is a component signal. The audio signal output unit 17B transmits the received second audio signal to the external audio signal input unit 14B via the RCA stereo cable.

The external video signal input unit 13B transmits the received second video signal to the video synthesizing unit 5A. The external audio signal input unit 14B transmits the received second audio signal to the audio selection unit 8.

With this configuration, the television receiver 200 can perform a display of the video and an output of the audio, using the video signal and the audio signal which are transmitted from the player 302.

Namely, at least one of the first through sixth video signals and at least one of the first through sixth audio signals are the signals obtained from a recording medium.

Moreover, at least one of the first through sixth video signals and at least one of the first through sixth audio signals are the signals obtained from a tuner.

Note that in the playback device 1000A according to the present embodiment, a reproduction unit may be configured by the video decoders 2A, 2B, 2C, 2D, 2E, and 2F, and the audio decoders 3A, 3B, 3C, 3D, 3E, and 3F. Namely, the playback device 1000A may be configured to include a reproduction unit that includes the video decoders 2A, 2B, 2C, 2D, 2E, and 2F, and the audio decoders 3A, 3B, 3C, 3D, 3E, and 3F.

The instruction receiving unit 6A has the same function as that of the instruction receiving unit 6 in FIG. 1; therefore, the detailed description shall not be repeated. The following is a brief explanation of the instruction receiving unit 6A.

The instruction receiving unit 6A transmits instructions to each of the components in the television receiver 200 through the operations using buttons (keys) that are set in the television receiver 200 and the remote control operations U that have already been described above. The button operations and the remote control operations U are not restricted to normal TV operations such as power-on/off operation, tuner selecting operation, and volume control operation.

Through the characteristic operations of the device capable of displaying a multi video, it is possible to give instructions, to the video synthesizing unit 5A, on the number of screens displaying videos and the layout for each video, as well as instructions, to the audio signal selection unit 8, on which audio signal should be selected.

More precisely, by receiving a control signal that indicates a control instruction, the instruction receiving unit 6A accepts the control instruction, as is the case of the instruction receiving unit 6. The control instruction is one of a playback control instruction, a video composition instruction, an audio selection instruction, and the like.

In the case where the received control instruction is a playback control instruction, the instruction receiving unit 6A transmits the playback control instruction to the reproduction unit 100A and the playback state management unit 7A.

Moreover, a television receiver, in general, receives only the key codes of a remote controller adapted for the television receiver. However, the television receiver 200 according to the present embodiment can receive also the key codes of a remote controller adapted for the player 302 and determine which operation has been performed.

The remote controller codes which are assigned for each maker for performing basic operations of a player are widely known. Universal remote controllers adapted for any sorts of AV devices manufactured by different makers as well as learning remote controllers which receive and learn the key codes of a remote controller of a different maker and transmit the key codes are on the market.

Therefore, even with a player of a different maker, it is easy to receive the key codes of a remote controller of a maker different from that of the player and to detect which operation has been performed.

The OSD unit 4 in FIG. 3 has the same function as that of the OSD unit 4 in FIG. 1; therefore, the detailed description shall not be repeated. Namely, the OSD unit 4 transmits, when necessary, an OSD video signal to the video synthesizing unit 5A.

The video synthesizing unit 5A has the same function as that of the video synthesizing unit 5 in FIG. 1; therefore, the detailed description shall not be repeated. The following is a brief description of the synthesizing unit 5A.

The video synthesizing unit 5A receives the first through sixth video signals which have been described above. Hereinafter, each of the first through sixth video signals is also simply referred to as “video signal”.

The video synthesizing unit 5A selects two or more and four or less video signals from the six received video signals, and generates a multi video representing the videos represented by the respective selected video signals. Note that in the generation of the multi video, the size of the images represented by the multi video is reduced by the video synthesizing unit 5A when necessary.

Moreover, the video synthesizing unit 5A causes the image represented by the OSD signal to overlap onto the generated multi video, when necessary.

The video synthesizing unit 5A then transmits the multi video signal representing the multi video to the multi video display unit 9A.

Note that the video synthesizing unit 5A may select one video signal. In this case, a multi video is not generated.

The multi video display unit 9A displays the multi video represented by the multi video signal. More precisely, by displaying the multi video, the multi video display unit 9A outputs the multi video. Namely, the multi video display unit 9A is a video output unit which performs processing for outputting a multi video.

Moreover, the video synthesizing unit 5A also transmits, together with the multi video signal, a video signal of the video that is currently being operated out of the videos represented by the multi video, to the playback state management unit 7A. Here, the video that is currently being operated is, for instance, a video of which the playback state has been changed to a special playback state, as has already been described above, through the remote control operation U by the user. Hereinafter, the video that is currently being operated is referred to as “currently-operated video”.

In the following, a video signal of the currently-operated video among the videos represented by the multi video is also referred to as “currently-operated video signal VSIG”. In this case, the currently-operated video signal VSIG is one of the first through sixth video signals. The currently-operated video signal VSIG represents a video (moving image) composed of frames.

The audio selection unit 8 receives the first through sixth audio signals which have been described above. Hereinafter, each of the first through sixth audio signals is simply referred to as “audio signal”.

The audio signal selection unit 8 selects one audio signal among the six received audio signals according to an external instruction, and transmits the selected audio signal to the audio signal output unit 10.

Moreover, the audio selection unit 8 also transmits, together with the selected audio signal, an audio signal that corresponds to the currently-operated video among the videos represented by the multi video, to the playback state management unit 7A.

Hereinafter, an audio signal that corresponds to the currently-operated video among the videos represented by the multi video is also referred to as “currently-operated audio signal ASIG”. In this case, the currently-operated audio signal ASIG is one of the first through sixth audio signals. Namely, the audio signal selection unit 8 transmits the currently-operated audio signal ASIG to the playback state management unit 7A.

The audio signal output unit 10 transmits the received audio signal to the speaker. That is to say that the audio signal output unit 10 externally outputs the received audio signal. The speaker outputs the audio represented by the received audio signal.

Note that the audio signal output unit 10 may include a speaker. In this case, the audio signal output unit 10 outputs an audio from the speaker based on the received audio signal.

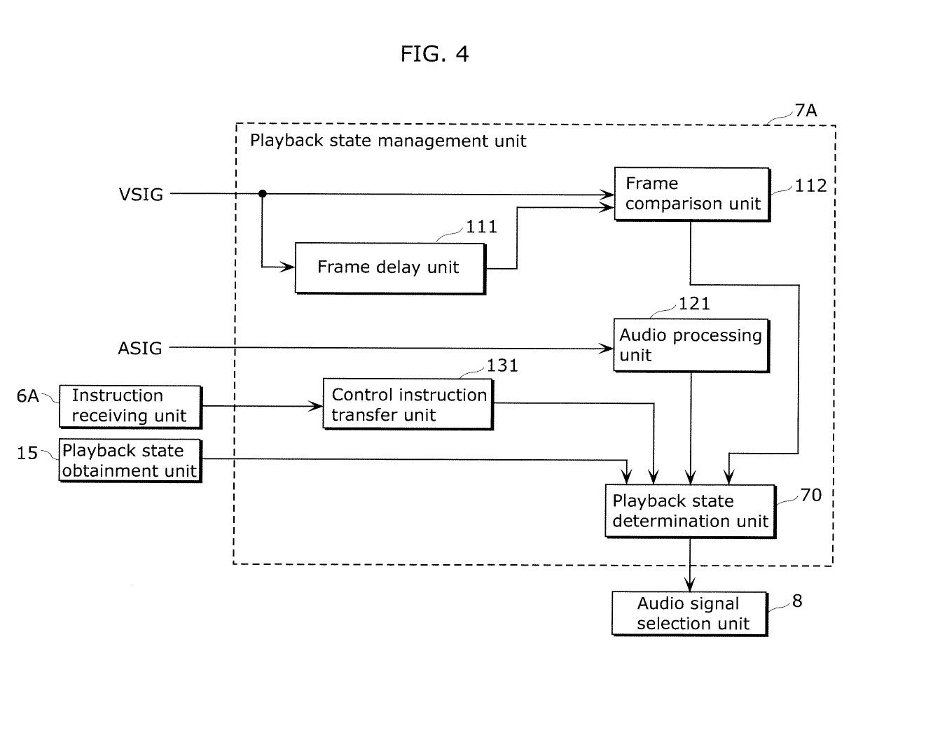

FIG. 4 is a block diagram showing a configuration of the playback state management unit 7A.

The playback state management unit 7A receives a currently-operated video signal VSIG, a currently-operated audio signal ASIG, an instruction from the instruction receiving unit 6A, a playback state, and others.

As shown in FIG. 4, the playback state management unit 7A includes a frame delay unit 111, a frame comparison unit 112, an audio processing unit 121, a playback state determination unit 70, and a control instruction transfer unit 131.

The frame display unit 111 and the frame comparison unit 112 receive a currently-operated video signal VSIG.

The frame delay unit 111 transmits each of the frames in the currently-operated video signal VSIG to the frame comparison unit 112 with a delay equivalent of one frame period. Here, a period in which each of the frames composing the currently-operated video signal VSIG is processed is determined to be one frame period. One frame period is, for instance, 1/59.97 seconds which is a period of time that is conceived to be average for consumer equipment in Japan.

Thus, the frame comparison unit 112 receives, per one frame period, a current frame and a past frame in the currently-operated video signal VSIG at almost the same time. A current frame is the latest frame and a past frame is a frame prior to the current frame in terms of time.

Whenever receiving a current frame and a past frame, the frame comparison unit 112 compares the current frame and the past frame.

The audio processing unit 121 receives the currently-operated audio signal ASIG, and processes the currently-operated audio signal ASIG, which will be described in detail later.

As has been described above, the playback state determination unit 70 receives the playback state information which indicates a playback state of a signal that is presently being reproduced by the player 301, from the playback state obtainment unit 15 (player 301). More precisely, the playback state determination unit 70 determines a playback state (operating state) of the player 301 based on the playback state indicated in the received playback state information.

In other words, the playback state management unit 7A (playback state determination unit 70) receives, via the playback state obtainment unit 15, the playback state information which indicates a playback state (operating state) of the player 301 and is transmitted from the player 301.

However, the player 302 does not have a communication means to notify a playback state (operating state). Thus, the playback state management unit 7A is not capable of obtaining a playback state (operating state) of the player 302 via a playback state obtainment unit.

Here is an example in which the multi video display unit 9A displays a multi video representing the first through fourth videos, and the second video is a currently-operated video. More precisely, the second video represented by the second video signal transmitted from the player 302 is a currently-operated video.

The determination methods A, B, and C for determining, in such case, whether or not it is possible to switch the audio that is presently being played from the second audio corresponding to the second video to other audio are described below.

The determination method A is a method based on the comparison between a current frame and a past frame which are included in a currently-operated video signal VSIG. More precisely, whenever receiving a current frame and a past frame, the frame comparison unit 112 calculates a similarity indicating a degree of similarity between the current frame and the past frame.

In the following, the similarity between a current frame and a past frame is also referred to as “frame similarity”. The method for calculating the similarity between the two frames has already been known; therefore, the detailed description shall not be given. The frame similarity is indicated in the range of 0 to 100%.

The frame similarity can be obtained, for example, by calculating a difference value between each of the pixel values of the pixels composing a current frame and each of the pixel values of the pixels composing a past frame. In this case, the smaller an average value of the absolute values of the respective difference values becomes, the closer the frame similarity gets to 100%.

In the case where the frame similarity is 100%, for instance, a current frame and a past frame are the same frame. In the case where the frame similarity is 90%, for instance, a current frame and a past frame are almost the same frame.

In the case where the frame similarity is 20%, this indicates the low possibility that a current frame and a past frame are the same frame.

Each time of calculating a frame similarity, the frame comparison unit 112 transmits the frame similarity to the playback state determination unit 70.

Whenever receiving a frame similarity, the playback state determination unit 70 determines a playback state of the currently-operated video signal VSIG.

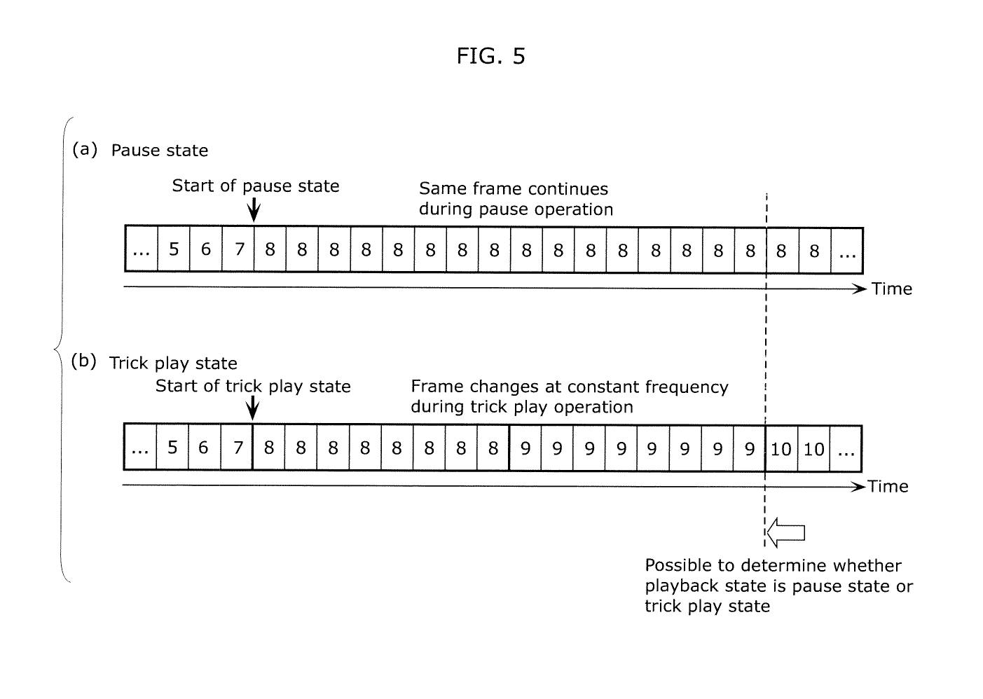

In the case of receiving a frame similarity indicating a value greater than a predetermined similarity threshold value (e.g., 90%) for a predetermined period of similarity determination time (e.g., one second) or longer, the playback state determination unit 70 determines that a playback state of a currently-operated video signal VSIG is a pause state (see reference to (a) in FIG. 5). Namely, it is possible to determine that the second audio signal from the player 302 is a signal indicating that an audio of the second audio signal is silent. Here, the similarity determination time is a time for determining whether or not the frames are similar.

In the case where a playback state of a currently-operated video signal VSIG is a trick play state (e.g., fast-forward state, reverse state, etc.), the frame changes at certain intervals (e.g., 0.1 second), as shown in (b) in FIG. 5.

Thus, in the case where the frame similarity received from the frame comparison unit 112 changes at intervals of frequency determination time (e.g., 0.1 second), the playback state determination unit 70 determines that the playback state of the currently-operated video signal VSIG is a trick play state (e.g., fast-forward state, reverse state, etc.). That is to say that the trick play state as a special video playback state is a state in which the video represented by the video signal (currently-operated video signal VSIG) of which the playback state is to be determined by the playback state determination unit 70 changes at a constant frequency.

More precisely, the playback state determination unit 70 determines that the playback state of the currently-operated video signal VSIG is changed from a normal playback state to a trick play state.

The playback state determination unit 70 is thus capable of determining that a playback state of the currently-operated video signal VSIG is a pause state or a trick play state. Therefore, the playback state determination unit 70 is capable of more delicate selection control of the audio signal.

Note that with the configuration according to the present embodiment, the currently-operated video signal VSIG is a component signal outputted from the player 302, in some cases. The component signal has less noise compared to a composite signal, and yet in some cases, a perfect pixel matching cannot be achieved due to the component signal being an analog signal. Thus, it is desirable to set a threshold value for allowing accidental errors to some extent.

The determination method B is a method for determining whether or not a currently-operated audio signal ASIG is a signal that indicates that an audio of the currently-operated audio signal ASIG is silent.

More precisely, the audio processing unit 121 performs sampling on the currently-operated audio signal ASIG, and calculates, every predetermined period of time (e.g., 100 milliseconds), an average value of the volumes (referred to as “volume value”) of the audio represented by the currently-operated audio signal ASIG. The volume value indicates a value ranged from 0 to 100, for instance. When a volume value indicates 0, a part of the currently-operated audio signal ASIG which corresponds to the predetermined period of time indicates that an audio of the currently-operated audio signal ASIG is silent.

Then, whenever calculating a volume value, the audio processing unit 121 transmits the volume value to the playback sate determination unit 70.

In the case of sequentially receiving a volume value that is smaller than a predetermined silence determination threshold value for a predetermined period of silence determination time or longer, the playback state determination unit 70 determines that the currently-operated audio signal ASIG indicates that the audio of the currently-operated audio signal ASIG is silent. The silence determination threshold value is, for instance, a threshold value for determining whether or not an audio is silent. The silence determination threshold value is, for instance, 10. The silence determination time is a time for determining whether or not an audio is silent.

When the second audio signal from the player 302 indicates that the second audio is silent for a predetermined silence determination time or longer, the playback state determination unit 70 determines that the second audio presently being played can be switched to another.

Note that in the determination method B, in the case where the currently-operated audio signal ASIG is a digital signal, it is possible to determine that the currently-operated audio signal ASIG is a silent signal with the volume level indicating 0. However, in the case where the currently-operated audio signal ASIG is an analog signal, it is desirable to set a threshold value for allowing accidental errors to some extent, considering that an analog signal is a static-ridden signal.

The determination method C is a method for virtually determining a state of a player based on button (key) operations using a remote controller to operate the player. The button (key) operations of the remote controller adapted for the player are performed to change the playback state of the player, and these operations (control instructions) can be obtained also from the instruction receiving unit 6A. Thus, it is possible to virtually determine a state of a player through the processing performed by the control instruction transfer unit 131 in the television receiver 200 without inquiring the player of its state.

More precisely, the control instruction transfer unit 131 receives a control instruction transmitted from the instruction receiving unit 6A, and transmits the received control instruction (playback control instruction) to the playback state determination unit 70. Thus, the playback state determination unit 70 is capable of virtually determining a playback state of the player 302.

Thus, the above description has illustrated the determination methods A, B, and C for determining whether it is possible or not to switch the audio presently being played from the second audio corresponding to the second video to a different audio. However, in the case of using one of the above-described methods A, B, and C alone, the determination accuracy is not so high.

In the case of the frame (pixel) comparison using the determination method A, it is difficult to handle random video noises which are generated, for instance, when a video is fast-forwarded or paused in the VTR operations. In some cases, an audio continues to be outputted although a video is paused, which is due to the performance of the content. This might cause some errors in the determination, and thus, it is not desirable to use only the determination method A.

In the case of using the determination method B for a content such as news and drama that needs intervals, a silent state is frequently generated. In this case, using only the determination method B causes a state in which the audios are frequently switched, which is not desirable.

In the case of using the determination method C, according to the disposition of the player 302 and the television receiver 200, as well as a transmission direction of a remote control signal (control instruction), only the player 302 obtains the remote control signal (control instruction) whereas the television receiver 200 cannot obtain the remote control signal. This generates the state in which a playback state of the player 302 differs from a playback state that has virtually been determined, which is not desirable.

Thus, it is required to contrive ways for the determination by combining (using AND condition) each of the results gained by the respective determination methods A, B, and C.

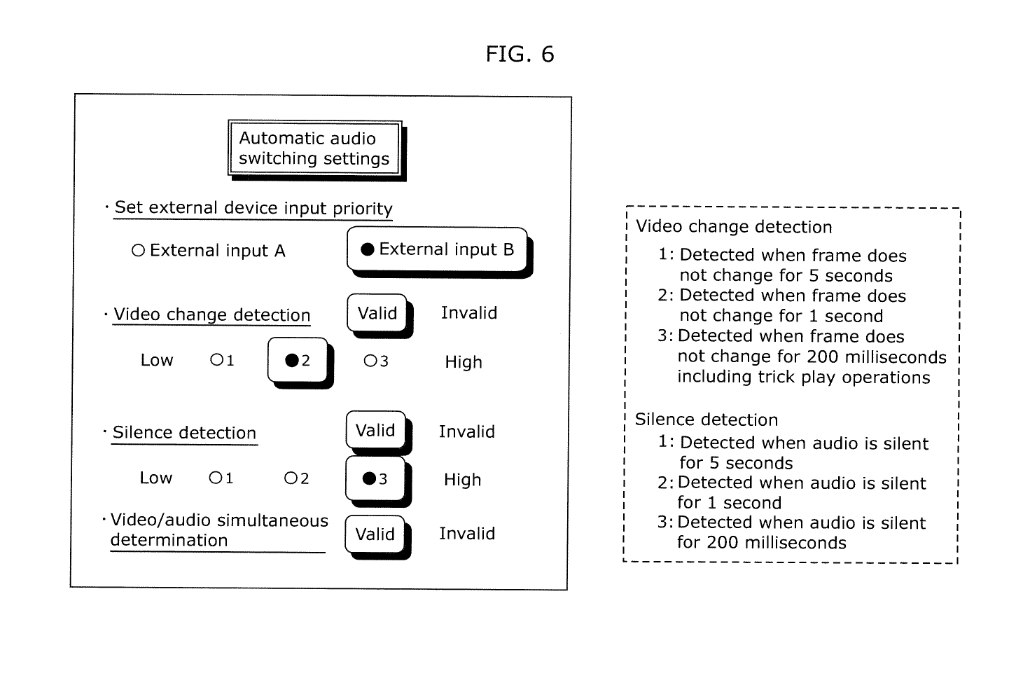

For example, by asking the user to previously determine the settings as described in FIG. 6, it is possible to provide an audio switching timing according to the user's preferences.

FIG. 6 is a diagram showing an example of settings for automatically switching an audio.

In the example of the settings shown in FIG. 6, for instance, processing as follows “setting a threshold value for video change (e.g., similarity determination time) in the determination method A as one second, setting a threshold value for silence detection (e.g., silence determination time) in the determination method B as 200 milliseconds, and when AND condition is satisfied, automatically switching, to a different audio, the audio that is presently being outputted” is performed.

More precisely, in the case of receiving a frame similarity indicating a value equal to or greater than a similarity threshold value for a period of time that is equal to or longer than the similarity determination time (one second), and also continuously receiving a volume value indicating a value equal to or smaller than a silence determination threshold value for a period of time that is equal to or longer than a silence determination time (e.g., 200 milliseconds), the playback state determination unit 70 determines that the currently-operated audio signal ASIG is a signal that indicates that an audio of the currently-operated audio signal ASIG is silent. Here, in the case where the currently-operated audio signal ASIG is a signal indicating that an audio of the currently-operated audio signal ASIG is silent, the playback state of the currently-operated audio signal ASIG is also referred to as “silent state”.

In this case, the playback state determination unit 70 determines that the playback state of the currently-operated video signal VSIG is a pause state, and also, the playback state of the currently-operated audio signal ASIG is a silent state.

The pause state is a special video playback state and the silent state is a special audio playback state.

Namely, the pause state as a special video playback state is a state in which the image (frame) represented by the video signal (currently-operated video signal VSIG) of which the playback state is to be determined by the playback state determination unit 70 remains the same or substantially the same for a predetermined period of time or longer.

That is to say that the silent state as a special audio playback state is a state in which an audio signal to be determined by the playback state determination unit 70 indicates that an audio of the audio signal is silent for a predetermined period of time or longer.

Note that the playback state of the currently-operated video signal VSIG, which is to be determined by the playback state determination unit 70, differs according to the control instruction. The playback state of the currently-operated video signal VSIG, which is to be determined by the playback state determination unit 70, is not limited to the pause state as has described above, and it may be a trick play state such as a fast-forward state and a reverse state.

The currently-operated video signal VSIG is one of the first through sixth video signals. Moreover, the currently-operated audio signal ASIG is one of the first through sixth audio signals.

In this case, the playback state determination unit 70 transmits an audio selection instruction for selecting the first audio signal, for instance. The audio selection instruction here is an instruction for switching the audio presently being played from the second audio to a different audio (e.g., the first audio). Here, the first audio signal shall be an audio signal of which the playback state has not been changed, and shall also be an audio signal that corresponds to the first video signal of which the playback state has not been changed.

The audio signal selection unit 8 selects the first audio signal according to the received audio selection instruction.

More precisely, in the case where the video playback state determined by the playback state determination unit 70 is a special video playback state, and also, the audio playback state determined by the playback state determination unit 70 is a special audio playback state, the audio signal selection unit 8 functioning as a selection unit selects, from among the audio signals, an audio signal of which the playback state has not been changed and which corresponds to the video signal of which the playback state has not been changed.

Note that the playback state determination unit 70 may prioritize the playback states which have already been determined. For example, the playback state determination unit 70 has determined the playback states of the currently-operated video signal VSIG and the currently-operated audio signal ASIG, and the user has previously set priority settings so that a priority is given to the playback sate of the video signal during the operation.

In this case, the playback state determination unit 70 determines the playback states of the currently-operated video signal VSIG and the currently-operated audio signal ASIG, and gives priority to the playback state of the currently-operated video signal VSIG over the playback state of the currently-operated audio signal ASIG during the operation.

Namely, the playback state determination unit 70 determines the playback states and prioritize these playback states.

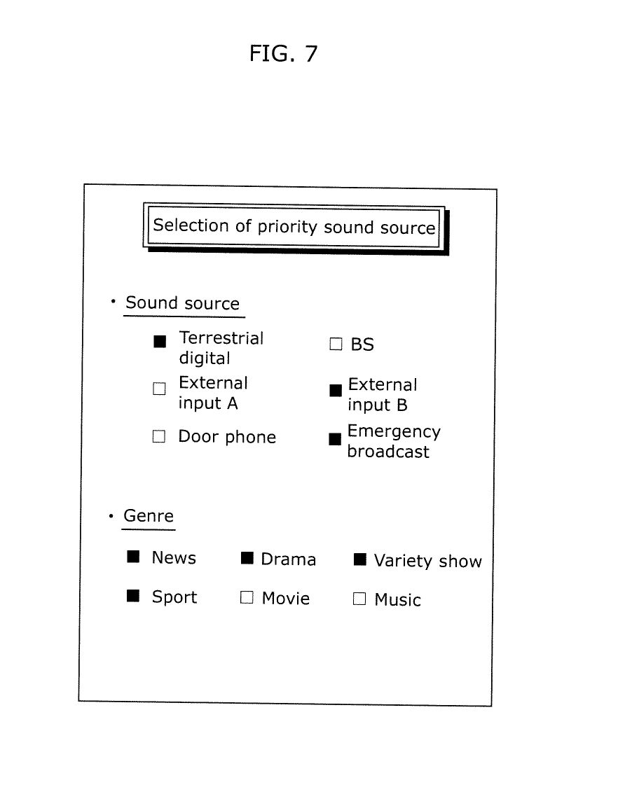

Moreover, by asking the user to previously determine the settings as shown in FIG. 7, it is possible to select a sound source (audio signal) that reflects the user's preference even in the case where plural sound sources (audio signals) are provided for selection.

FIG. 7 is a diagram showing an example of settings in the case where several audio signals are provided for selection.

For example, a priority sound source is selected as shown in FIG. 7, and the multi video display unit 9A shall display a multi video P100 as described below.

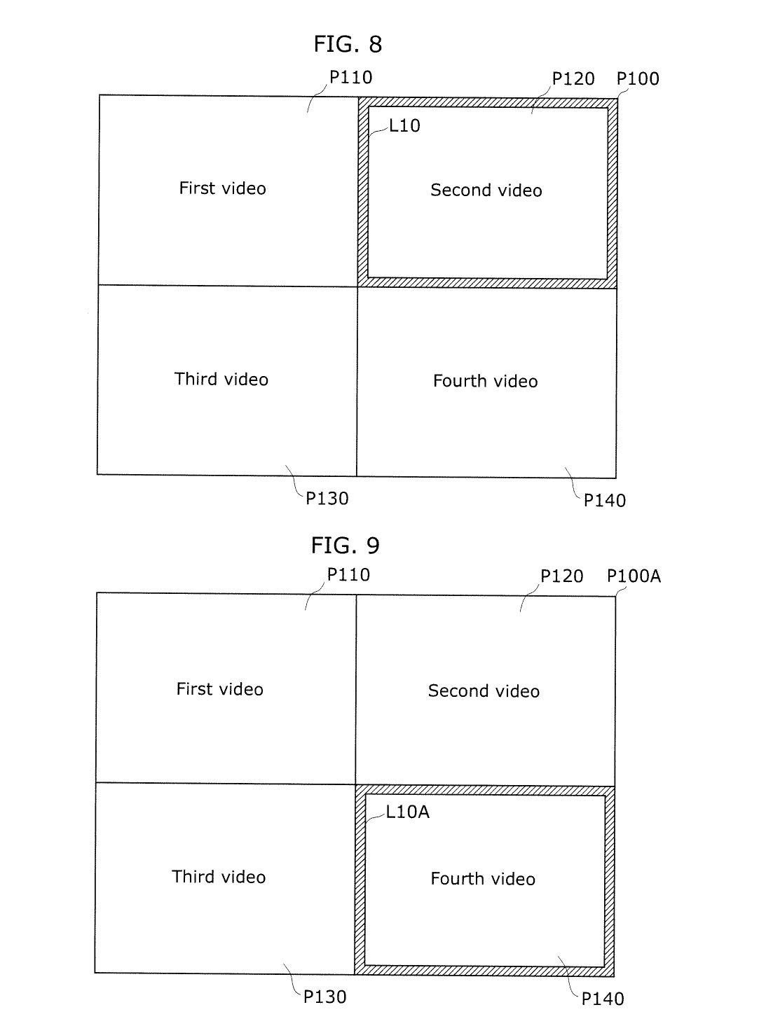

FIG. 8 is a diagram showing a multi video P100 as an example.

As shown in FIG. 8, the multi video P100 shows the first video P110, the second video P120, the third video P130, and the fourth video P140. The first video P110 is a video represented by the first video signal received from the player 301. The second video P120 is a video represented by the second video signal received from the player 302.

The third video P130 is a video obtained through the decoding (reproduction) of the broadcast video signal from the tuner 12C. The third video P130 is, for instance, a video showing a music program whose genre is music.

The fourth video P140 is a video obtained through the decoding (reproduction) of the broadcast video signal from the tuner 12D. The fourth video P140 is, for instance, a video showing a sport program whose genre is sport.

On the television receiver 200 according to the present embodiment, an audio output frame is displayed in the periphery of the image so that the user can easily recognize the video that is corresponded to the audio which is presently being outputted.

Moreover, the audio signal output unit 10 transmits (outputs) the second audio signal corresponding to the second video P120 to the external speaker. Namely, the second audio corresponding to the second video P120 is outputted from the speaker.

In this case, in order to show that the second audio corresponding to the second video P120 is being outputted, an audio output frame L10 as shown in FIG. 8, for instance, is displayed in the periphery of the second video P120. In other words, the second video is displayed in a manner different from that of the first, third and fourth videos in the multi video.

In other words, the video, which corresponds to the audio signal that has been selected by the audio signal selection unit 8 functioning as a selection unit from the videos composing the multi video, is displayed in a manner different from that of the other videos.

The following is an example. The priority is set as shown in FIG. 7, and the multi video display unit 9A displays, for example, the multi video P100 as shown in FIG. 8. Moreover, the audio switching is set as shown in FIG. 6. The remote control operation U is performed by the user to change a playback state of the second video signal being reproduced by the player 302 to a pause state, and the playback state of the second video signal (player 302) has been changed to a pause state.

In this case, the playback state determination unit 70 determines that the audio represented by the second audio signal transmitted from the second video signal (player 302) has become silent, according to the setting conditions shown in FIG. 6. In FIG. 7, as for the genre, music is not selected and sport is selected. Therefore, the playback state determination unit 70 performs processing for selecting, in priority to other audio signals, the fourth audio signal that corresponds to the fourth video P140 showing a sport program whose genre is sport.

More precisely, the playback state determination unit 70 transmits an audio selection instruction for selecting the fourth audio signal to the audio signal selection unit 8. The audio signal selection unit 8 selects the fourth audio signal according to the reception of the audio selection instruction, and transmits the fourth audio signal to the audio signal output unit 10. Then, through the same processing as described above performed by the audio signal output unit 10, the fourth audio is outputted from the speaker.

Namely, the audio of the tuner 12D, which transmits the broadcast video signal that corresponds to the video showing a sport program whose genre is sport, is outputted in preference to other videos.

In other words, the audio signal selection unit 8 functioning as a selection unit selects one of the audio signals based on the playback state determined by the playback state determination unit 70 and the priority for selecting one of the audio signals.

Note that the video displayed by the multi video display unit 9A is not limited to a video like the multi video P100 shown in FIG. 8, in which four videos are laid out. It may be, for instance, a single video or a multi video representing two videos.

Moreover, the multi video is not limited to a video in which four videos are laid out like the multi video P100 shown in FIG. 8. It may be a multi video representing four videos in a layout different from the one shown in FIG. 8.

As has been described above, on the television receiver 200 according to the present embodiment, an audio output frame is displayed in the periphery of the video that is corresponded to the audio presently being outputted, so that the corresponding video is easily recognized.

Note that the television receiver 200 according to the present embodiment may be configured to cause the audio output frame to blink on and off for a predetermined period of time (e.g., three seconds) or longer in the case where the audio being played has been switched to another.

For example, in the case where the multi video display unit 9A displays the multi video P100 in FIG. 8, the remote control operation U is performed by the user and the playback state of the second video is changed to a pause state. Namely, the second video has become a currently-operated video. The second audio signal corresponding to the second video indicates that the second audio is silent.

In this case, through the above-described processing in which the determination methods A, B, and C are combined, as well as the processing in which priority is taken into consideration as described above for FIG. 7, the playback state determination unit 70 transmits an audio selection instruction for selecting the fourth audio signal, for instance, to the audio signal selection unit 8.

Through the same processing as described above performed by the audio signal selection unit 8 and the audio signal output unit 10, the fourth audio is outputted from the speaker. Note that the audio signal selection unit 8 transmits audio selection information that indicates the selected audio signal, to the video synthesizing unit 5A. Here, the audio selection information is information that indicates that the fourth audio signal has been selected.

Upon receiving the audio selection information, the video synthesizing unit 5A generates a multi video P100A in which an audio output frame L10A blinks on and off in the periphery of the fourth video represented by the multi video P100, and causes the multi video display unit 9A to display the multi video P100A. The multi video P100A is a video in which the audio output frame L10A blinks on and off for a predetermined period of time (e.g., three seconds).

FIG. 9 is a diagram showing the multi video P100A as an example.

As shown in FIG. 9, in the multi video P100A, the audio output frame L10A is displayed in the periphery of the fourth video P140. Note that the audio output frame L10A blinks on and off for a predetermined period of time (e.g., three seconds). Namely, the video (the fourth video) corresponding to the audio signal, which has been selected from among the video composing the multi video by the audio signal selection unit 8 functioning as a selection unit, is a video of which the periphery blinks on and off.

The playback device 1000A according to the present embodiment as has been described above performs processing corresponded to each kind of playback state (hereinafter, also referred to as “playback state handling processing A”).

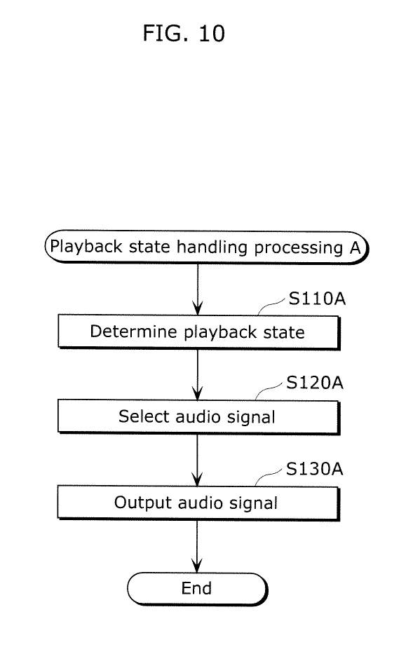

FIG. 10 is a flowchart showing the playback state handling processing A.

As has been described above, the playback state determination unit 70 determines a playback state of the currently-operated video signal VSIG which is one of the first through sixth video signals, using the frame similarities received from the frame comparison unit 112. The playback state determination unit 70 also determines a playback state of the currently-operated audio signal ASIG which is one of the first through sixth audio signals, using the volume values received from the audio processing unit 121.

In other words, the playback state determination unit 70 determines the playback state of at least one video signal (currently-operated video signal VSIG) among the video signals, and the playback state of at least one audio signal (currently-operated audio signal ASIG) among the audio signals (S110A). Namely, the playback state determination unit 70 determines at least one of the following: a playback state of at least one of the video signals; and a playback state of at least one of the audio signals (S110A).

Moreover, the playback state determination unit 70 is capable of determining a playback state of the player 302, that is, a playback state of the currently-operated video signal VSIG, using a control instruction (playback control instruction) received from the control instruction transfer unit 131. The control instruction (playback control instruction) is an instruction for changing a playback state of the currently-operated video signal VSIG among the video signals.

Here, the control instruction (playback control instruction) received by the playback state determination unit 70 from the control instruction transfer unit 131 is an external instruction which is transmitted from a remote controller through the remote control operation U.

In other words, such external instruction (control instruction (playback control instruction)) is an instruction transmitted from the remote controller for changing a playback state of one of the video signals.

As has already been described above, in the case of determining, for instance, that a playback state of the currently-operated video signal VSIG is a pause state, and also determining that a playback state of the currently-operated audio signal ASIG is a silent state, the playback state determination unit 70 transmits an audio selection instruction for selecting the first audio signal, for instance, to the audio signal selection unit 8.

Note that the playback state determination unit 70 may determine at least one of a playback state of the currently-operated video signal VSIG and a playback state of the currently-operated audio signal ASIG according to the external instruction (control instruction (playback control instruction)).

For example, in the case where the control instruction (playback control instruction) is an instruction for changing a playback state of the currently-operated video signal VSIG to a pause state, the playback state determination unit 70 determines that a playback state of the currently-operated video signal VSIG is a pause state according to the control instruction (playback control instruction).

In other words, the playback state determination unit 70 determines at least one of the following according to an external instruction (control instruction (playback control instruction)): a video playback state that is a playback state of at least one of the video signals; and an audio playback state that is a playback state of at least one of the audio signals.

The audio signal selection unit 8 selects the first audio signal, for instance, according to the received audio selection instruction (S120A). In other words, the audio signal selection unit 8 functioning as a selection unit selects one of the audio signals based on the video playback state and the audio playback state.

Then, the audio signal selection unit 8 transmits the selected first audio signal to the audio signal output unit 10.

The audio signal output unit 10 transmits (outputs) the first audio signal to the external speaker (S130A). Namely, the audio signal output unit 10 outputs the audio signal selected by the audio signal selection unit 8 functioning as a selection unit.

As has been described above, according to the present embodiment, the playback state management unit 7A determines the playback states of a video and an audio, and performs processing for selecting an audio signal according to the determined playback states, as is the case described in Embodiment 1.

More precisely, the playback state determination unit 70 determines a video playback state that is a playback state of at least one video signal (currently-operated video signal VSIG) among plural video signals, and an audio playback state that is a playback state of at least one audio signal (currently-operated audio signal ASIG) among plural audio signals. The audio signal selection unit 8 selects one of the audio signals based on the video playback state and the audio playback state which have been determined by the playback state determination unit 70.

Thus, by the fact that the audio signal selection unit 8 selects one of the audio signals (the first through sixth audio signals) based on the video playback state and the audio playback state, user's operation or the like is not required in the selection of the audio signal. This enables a rapid selection of an audio that corresponds to the multi video.

With the conventional technique, in a state where a playback state of the first video (the first video signal) is a special state (pause state, fast-forward state, etc.) and the first audio is silent (hereinafter referred to as “state A”), user's operation is necessary for outputting another audio different from the first audio.

However, in the present embodiment, it is possible in the state A to output a different audio without any user's operation. This enables the user to effectively view in parallel the videos received from the players 301 and 302, the videos obtained from the tuners 12C to 12F, and others.

According to the present embodiment, it is configured to set plural conditions for switching between the audio signals and prioritize these conditions. With this configuration, it is possible to determine, with high accuracy, a playback state (operating state) of the player even under the circumstances in which a playback state (operating state) of the player cannot be obtained through communications.

Moreover, according to the present embodiment, it is configured to prioritize an audio signal (sound source) to be switched, a video that corresponds to the sound source, and the like. Thus, it is possible to perform automatic sound source selection according to the user's preferences.

Furthermore, according to the present embodiment, the selection of an audio signal to be outputted is performed based on playback states. Thus, it is possible to present an audio which corresponds to another video and is not to be outputted or different music data that is recorded in a recording medium, even when a playback state of one of the videos represented by a multi video is a special playback state. This produces an effect of enabling the user to effectively view plural contents in parallel.

Thus, it is possible to make the parallel viewing of plural contents more accessible. Moreover, at the time of content viewing using a player, it is possible to perform audio switching according to the user's preferences.

Moreover, the present embodiment has enabled the switching of output audio in association with playback states, and thus, it is possible to perform the audio switching between a main screen and a sub screen in one step, which has been complicated with the conventional technique.

Furthermore, by enabling switching of an output audio only, it is possible to provide a viewing of an image on a different screen without imposing on the viewer an unnecessary burden to move the viewpoint, which has been caused with the conventional technique.

In addition, a state of the player can be detected with the use of a video display (television receiver) only, so that it is possible to automatically perform audio switching without a configuration with which the player transmits its operating state to the video display.

According to the present embodiment, one video among the videos represented by a multi video shall be a video obtained from the player and the other videos shall be broadcast videos received by tuners. With this, it is possible to effectively use a multi-screen without any need for more players. This produces an effect of enabling the user to effectively view contents in parallel.

Moreover, according to the present embodiment, even a sound source which is not recorded in the recording medium of the playback device can be inputted via an external audio signal input unit. This produces an effect of not requiring any unnecessary use of the capacity of the recording medium in the playback device, and also an effect of enabling the user to more effectively view contents in parallel.

Moreover, according to the present embodiment, the playback device has a feature to receive playback states by the playback state obtainment unit. Thus, the playback device can obtain the same effects as described in Embodiment 1, even without a playback state management unit. This produces an effect of reducing the number of components in a playback device and thus lowering the cost of the device.

Moreover, according to the present embodiment, it is possible to recognize a playback state of the player 302 even in the case of combining the television receiver 200 and the player 302 that does not have a means to notify the television receiver 200 of a playback state of the player 302.

Moreover, according to the present embodiment, even in the case of combining the television receiver 200 and the player 302 that does not have a means to notify the television receiver 200 of a playback state of the player 302, it is possible to obtain an effect of enabling the management of a playback state of another player through the reception of the key codes of a remote controller by the playback device.

Moreover, according to the present embodiment, it is possible to directly obtain accurate playback states from the player. It is thus possible to obtain an effect of enabling more rigorous management of the playback states.

Moreover, according to the present embodiment, even in the case of combining the television receiver 200 and the player 302 that does not have a means to notify the television receiver 200 of a playback state of the player 302, it is possible to determine that a playback state of the player 302 is a pause state when the pixels of a video signal do not change for a predetermined period of time. Thus, it is possible to obtain an effect of enabling the management of a playback state of another player.

Moreover, according to the present embodiment, even in the case of combining the television receiver 200 and the player 302 that does not have a means to notify the television receiver 200 of the playback state of the player 302, it is possible to determine that a playback state of a video signal is a trick play state when changes are detected in the pixels of the video signal at a constant frequency. It is thus possible to obtain an effect of enabling the management of a playback state of another player.

Moreover, according to the present embodiment, even in the case of combining the television receiver 200 and the player 302 that does not have a means to notify the television receiver 200 of a playback state of the player 302, it is possible to determine that a playback state of the player 302 is a pause state or a trick play state, each of which has conventionally been a silent state. Thus, it is possible to obtain an effect of enabling the management of a playback state of another player.

Moreover, according to the present embodiment, even in the case of combining the television receiver 200 and the player 302 that does not have a means to notify the television receiver 200 of a playback state of the player 302, it is possible to obtain an effect of enabling an accurate determination of the playback state by combining plural playback states.

Moreover, according to the present embodiment, by adding a feature of each playback state determination unit, such as a time required for the determination of a playback state and accuracy in the determination, it is possible to obtain an effect of enabling the enhancement in the range of settings for deciding on which of response speed and accuracy an importance shall be given for selecting an audio signal.

According to the present embodiment, in a special case where a multi video represents three or more videos, audio selection is performed based on the analysis of videos and audios using priority settings. It is thus possible to obtain an effect of enabling the provision of a sound source according to the user's preferences.

According to the present embodiment, in the special case where a multi video represents three or more videos, even when an audio of another video is automatically selected by the audio signal selection unit, the periphery of the video of the selected audio is fringed in a specific color. That is to say that a frame is displayed.

With this, it is possible to visibly recognize with ease which video corresponds to the audio to which the previous audio has been switched. It is thus possible to obtain an effect of enabling instant recognition on the video corresponding to the audio that is presently being outputted.

According to the present embodiment, an audio output frame is caused to blink on and off for display. Thus, it is possible to visibly recognize with ease which video corresponds to an audio to which the previous audio has been switched even when a color of the audio output frame displayed for the video whose audio is presently being outputted is similar to a color of the periphery of the audio output frame which is the part displaying the video of the presently-outputted audio. It is thus possible to obtain an effect of enabling instant recognition of the video corresponding to the audio that is presently being outputted.

Moreover, the playback state handling processing in FIG. 2 or the playback state handling processing A in FIG. 10 may be executed by a computer. Thus, it is possible to make the use of a computing power of the computer, which is performed with the speed higher than that of the consumer equipment, and a storage medium having a capacity larger than that of the consumer equipment.

Thus, it is possible to obtain an effect of enabling the achievement of multiscreen simultaneous viewing which has been difficult with the consumer equipment, as well as the achievement of flexible function enhancement.

Note that in the present embodiment, it is configured that the tuners 12C, 12D, 12E and 12F in the television receiver 200 receive broadcast waves from an antenna; however, the present invention is not limited to this. For example, the television receiver 200 may be configured to be connectable to the Internet instead of having the tuners, an external video signal input unit, and an external audio signal input unit, so as to receive/play Video On Demand (VOD) contents, Internet radio and streaming broadcasts via a network.

Moreover, in the present embodiment, it is configured that the television receiver 200 includes four tuners; however, the present invention is not limited to this configuration. For example, the number of tuners may be made less by distributing signals within the television receiver 200. Thus, it is possible to control the cost of manufacturing the television receiver 200, and to reduce its mounting area. Furthermore, the television receiver 200 may be equipped with an additional tuner for receiving BS broadcasts and CS broadcasts.

Moreover, in the present embodiment, Ethernet (registered trademark) is used as a communication means for communications between the playback state obtainment unit 15 and the player 301; however, the present invention is not limited to this. A different communication means, such as HDMI-CEC, a wireless LAN (IEEE 802.11a/b/g/n), and RS-232C, which can send and receive playback states may be used instead.

This is because the method of expressing playback states (e.g., each state is held by such bytes and each value indicates such state) shall be matched between a player and a television receiver, and there is no need for high-speed communications since the size of the information used for expressing a playback state requires only few bytes.

Moreover, in the present embodiment, an HDMI cable, a component cable, and an RCA stereo cable are used as the cables for connecting the television receiver and the player; however, the present invention is not limited to this.

The video signals may be transmitted via a different video signal transmitting means such as a composite cable and an S terminal cable. The audio signals may be transmitted via a different audio transmitting means such as an optical cable equipped with an S/PDIF terminal in an input/output unit.

It is described in the present embodiment that the currently-operated video signal VSIG and the currently-operated audio signal ASIG are transmitted to the playback state management unit 7A as the prioritized audio signals (sound sources), and sound source (audio signal) priority information (e.g., sound source and genre) is an element used in the audio selection; however, the present invention is not limited to this.

For example, the signals from a device other than the player, such as a video and an audio obtained from the tuner, may be monitored, and if a signal matches the user's preference, a priority level of that signal may get higher. Moreover, a database may be created for the user's preferences based on face detection and metadata so as to increase a priority level according to casts and directors.

The priority may be changed according to the peak of a program. Moreover, by previously creating a database reflecting the user's preferences based on the programs the user frequently watches, an automatic selection of a sound source may be supported by adding the database information, even when the priority is set unchanged.

Moreover, in the present embodiment, it is configured that a video signal and an audio signal that are recorded in a recording medium are obtained from an external video signal input unit and an external audio signal input unit respectively; however, the present invention is not limited to this. For example, it may be configured that a recording medium is connectable to a television receiver so that either one or both of a video signal and an audio signal are obtained from the recording medium.

Moreover, in the present embodiment, it is described that the playback device shall include the television receiver 200 and the players 301 and 302; however, a point of division in the device may be changed. For example, the playback state determination unit that has the same function as that of the playback state management unit 7A may be set in the player 301, and instructions may be transmitted from the player 301 to the audio signal selection unit 8 in the television receiver 200.

In this case, the playback device is a playback device 1000B in FIG. 10 as described below. Note that the number of the tuners, the video decoders, and the audio decoders which are included in the playback device shall be two for each.

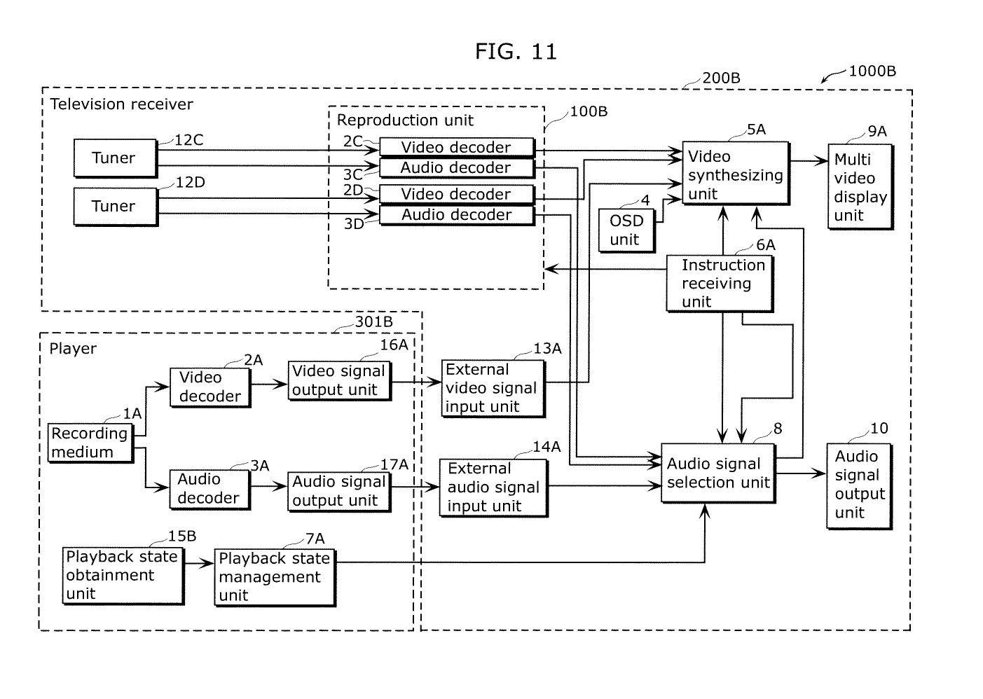

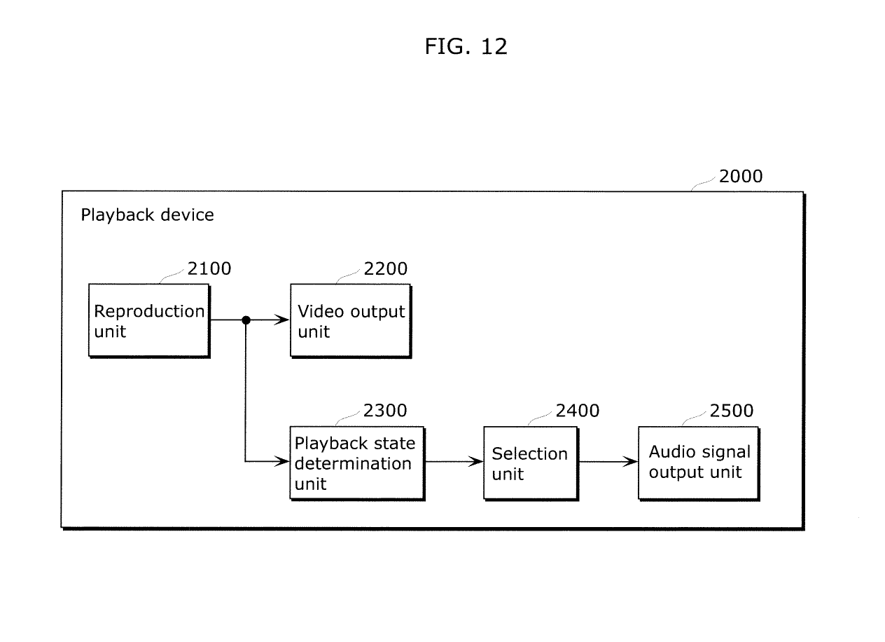

FIG. 11 is a block diagram showing a configuration of the playback device 1000B as an example.

The playback device 1000B includes a television receiver 200B and a player 301B.

The television receiver 200B differs from the television receiver 200 in FIG. 3 in that it includes a reproduction unit 100B instead of the reproduction unit 100A, and includes neither of the tuners 12E and 12F, the playback state management unit 7A, the playback state obtainment unit 15, the external video signal input unit 13B, and the external audio signal input unit 14B. Except for this, the configuration of the television receiver 200B is the same as that of the television receiver 200; therefore, the detailed description shall not be repeated.

The reproduction unit 100B differs from the reproduction unit 100A in that it includes neither of the video decoders 2E and 2F, and the audio decoders 3E and 3F. Except for this, the configuration of the reproduction unit 100B is the same as that of the reproduction unit 100A; therefore, the detailed description shall not be repeated.

The player 301B differs from the player 301 in FIG. 3 in that it includes the playback state obtainment unit 15B and the playback state management unit 7A, and includes neither of the playback state determination unit 18 and the playback state notification unit 19. Except for this, the configuration of the player 301B is the same as that of the player 301; therefore, the detailed description shall not be repeated.

The playback state obtainment unit 15B has a function to obtain a playback state of the player 301B, and transmits the obtained playback state to the playback state management unit 7A.

The playback state management unit 7A has the same function as the playback state management unit 7A as has been described above, and transmits, for instance, an audio selection instruction according to the playback state that has been received, to the audio signal selection unit 8.

With the configuration of the playback device 1000B as described above, it is possible to obtain the same effects as described in Embodiment 2.

Moreover, it is described in the present embodiment that the multi video display unit 9A in the television receiver 200 displays a multi video generated by the video synthesizing unit 5A; however, the present invention is not limited to this. For example, an external video signal output terminal may be set apart from the multi video display unit 9A, and the multi video generated by the video synthesizing unit 5A and part of the signal received by the video synthesizing unit 5A may be outputted from the external video signal output terminal to an external destination.

Moreover, in the present embodiment, the layout in FIG. 8 is illustrated as an example of the multi video generated by the video synthesizing unit 5A; however, the present invention is not limited to this. For example, the size of each video may not be the same. The same video may be displayed in plural, and the number of the videos represented by a multi video may not necessarily be four.

Moreover, in the present embodiment, the video decoders and the audio decoders are used as reproduction means; however, the present invention is not limited to this. For example, in the case where a video signal and an audio signal are not compression coded, reading a video and an audio from a recording medium and outputting them becomes equivalent to the reproduction means. Thus, the video decoders and the audio decoders are not always necessary, and the present invention may be configured without these decoders.

### (Functional Block Diagram)

FIG. 12 is a block diagram showing a characteristic and functional configuration of a playback device 2000. The playback device 2000 is an equivalent of either of the playback device 1000, the playback device 1000A, and the playback device 1000B. Namely, FIG. 12 is a block diagram showing the primary functions related to the present invention among the functions in either of the playback device 1000, the playback device 1000A, and the playback device 1000B.

The playback device 2000 performs processing using video signals and audio signals that respectively correspond to the video signals.

From a functional point of view, the playback device 2000 includes a reproduction unit 2100, a video output unit 2200, a playback state determination unit 2300, a selection unit 2400, and an audio signal output unit 2500. The reproduction unit 2100 performs reproduction of the video signals and the audio signals and is an equivalent of either one of the reproduction unit 100, the reproduction unit 100A, and the reproduction unit 100B. The video output unit 2200 performs processing for outputting a multi video that represents videos obtained respectively from the video signals through the reproduction performed by the reproduction unit 2100. The video output unit 2200 is an equivalent of the multi video output unit 9 or the multi video display unit 9A.

The playback state determination unit 2300 determines a playback state of at least one of the video signals and a playback state of at least one of the audio signals. The playback state determination unit 2300 is an equivalent, for instance, of the playback state determination unit 7 in FIG. 1 or the playback state determination unit 70 in FIG. 4.

The selection unit 2400 selects one of the audio signals based on the playback states determined by the playback state determination unit 2300. The selection unit 2400 is an equivalent of the audio signal selection unit 8.

The audio signal output unit 2500 outputs the audio signal selected by the selection unit 2400. The audio signal output unit 2500 is an equivalent of the audio signal output unit 10.

Note that all or part of the reproduction unit 2100, the video output unit 2200, the playback state determination unit 2300, the selection unit 2400, and the audio signal output unit 2500 which are included in the playback device 2000 may be configured in hardware such as a Large Scale Integration (LSI). All or part of the reproduction unit 2100, the video output unit 2200, the playback state determination unit 2300, the selection unit 2400, and the audio signal output unit 2500 may be a module of a program executed by a Central Processing Unit (CPU) or the like.

Thus, the playback devices 1000, 1000A, and 1000B are described based on the embodiments; however, the present invention is not restricted to these embodiments. As long as they do not depart from the essence of the present inventive concept, various modifications obtainable through modifications to the respective embodiments that may be conceived by a person of ordinary skill in the art as well as an embodiment composed by the combination of the constituent elements of different embodiments are intended to be included in the present inventive concept.

Moreover, all or part of the components composing each of the playback devices 1000, 1000A, and 1000B may be configured in hardware, or in a module of a program executed by a CPU. Moreover, all or part of the components composing each of the playback devices 1000, 1000A, and 1000B may be configured in a single system LSI. The system LSI is a super multi-functioned LSI manufactured by accumulating components on a chip. More concretely, the system LSI is a computer system consisting of a microprocessor, a Read Only Memory (ROM), a Random Access Memory (RAM), and others.

For example, in FIG. 1, the reproduction unit 100, the OSD unit 4, the video synthesizing unit 5, the instruction receiving unit 6, the playback state determination unit 7, the audio signal selection unit 8, the multi video output unit 9, and the audio signal output unit 10 may be configured in a single system LSI.

Moreover, the present invention may be realized as an audio selection method that includes, as steps, the operations of the characteristic components included in the respective playback devices 1000, 1000A, and 1000B. In addition, the present invention may be achieved as a program that causes a computer to execute the operations performed in the audio selection method. Furthermore, the present invention may be realized as a computer-readable recording medium which stores such program. The aforementioned program may be distributed via a transmitting medium such as the Internet.

The presently disclosed embodiments should be considered in all respects to be illustrative and not restricted. The scope of the invention is indicated by the appended claims rather than the foregoing description and all changes that come within the scope of the claims as well as within the meaning and range of equivalence are intended to be embraced therein.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable to a playback device which enables a rapid selection of an audio that corresponds to a multi video, and can be applied, in particular, to a video/audio playback device such as a television, a recorder, and a cell phone.

1. A playback device which performs processing using video signals and audio signals respectively corresponding to the video signals, the playback device comprising:
a reproduction unit configured to reproduce the video signals and the audio signals;
a video output unit configured to perform processing for outputting a multi video that represents videos respectively obtained from the video signals through the reproduction performed by the reproduction unit;
a playback state determination unit configured to determine at least one of: a playback state of at least one of the video signals; and a playback state of at least one of the audio signals;
a selection unit configured to select one of the audio signals based on the playback state determined by the playback state determination unit; and
an audio signal output unit configured to output the audio signal selected by the selection unit.

2. A playback device according to claim 1,
wherein the playback state determination unit is configured to determine a video playback state that is the playback state of the at least one of the video signals, and
the selection unit is configured to select one of the audio signals based on the video playback state determined by the playback state determination unit.

3. A playback device according to claim 1,
wherein the playback state determination unit is configured to determine a video playback state that is the playback state of the at least one of the video signals, and an audio playback state that is the playback state of the at least one of the audio signals, and
the selection unit is configured to select one of the audio signals based on the video playback state and the audio playback state.

4. A playback device according to claim 3,
wherein in the case where the video playback state determined by the playback state determination unit is a special video playback state and the audio playback state determined by the playback state determination unit is a special audio playback state, the selection unit is configured to select, from among the audio signals, an audio signal of which the playback state has not been changed and which corresponds to a video signal having an unchanged playback state.

5. A playback device according to claim 4,
wherein the special video playback state is a state in which an image represented by the video signal to be determined by the playback state determination unit remains substantially the same for a predetermined period of time or longer.

6. The playback device according to claim 4,
wherein the special video playback state is a state in which a video represented by the video signal to be determined by the playback state determination unit changes at a constant frequency.

7. A playback device according to claim 4,
wherein the special audio playback state is a state in which the audio signal to be determined by the playback state determination unit indicates that an audio is silent for a predetermined period of time or longer.

8. A playback device according to claim 1,
wherein the playback state determination unit is configured to determine, based on an external instruction, at least one of: a video playback state that is the playback state of the at least one of the video signals; and an audio playback state that is the playback state of the at least one of the audio signals, and
the external instruction is an instruction transmitted from a remote controller, for changing the playback state of one of the video signals.

9. The playback device according to claim 3, further comprising
a player which plays at least one of a video signal and an audio signal,
wherein the player outputs, to an external destination, playback state information which indicates a playback state of a signal presently being played, and
the playback state determination unit is configured to determine a playback state of the player based on the playback state information.

10. A playback device according to claim 1,
wherein the playback state determination unit is configured to determine playback states and to prioritize the playback states.

11. A playback device according to claim 1,
wherein the selection unit is configured to select one of the audio signals based on the playback state determined by the playback state determination unit and a priority for selecting one of the audio signals.

12. A playback device according to claim 1,
wherein a video which corresponds to the audio signal selected by the selection unit from among the videos that compose the multi video is displayed in a manner different from a manner in which the other videos are displayed.

13. The playback device according to claim 12,
wherein the video which corresponds to the audio signal selected by the selection unit from among the videos that compose the multi video is a video of which a periphery blinks on and off.

14. A playback device according to claim 1,
wherein at least one of the video signals and at least one of the audio signals are signals obtained from a recording medium.

15. A playback device according to claim 1,
wherein at least one of the video signals and at least one of the audio signals are signals obtained from a tuner.

16. A playback device according to claim 1 further comprising
an external audio signal input unit,
wherein at least one of the audio signals is an audio signal transmitted from a device that is connected to the external audio signal input unit.

17. An audio selection method for use in a playback device which performs processing using video signals and audio signals respectively corresponding to the video signals,
wherein the playback device includes:
a reproduction unit configured to reproduce the video signals and the audio signals; and
a video output unit configured to perform processing for outputting a multi video that represents videos respectively obtained from the video signals through the reproduction performed by the reproduction unit, and
the audio selection method includes:
determining at least one of: a playback state of at least one of the video signals; and a playback state of at least one of the audio signals;
selecting one of the audio signals based on the determined playback state; and
outputting the selected audio signal.

18. A non-transitory computer-readable recording medium for use in a computer, the recording medium having a computer program recorded thereon for causing a playback device to execute the audio selection method according to claim 17.
